(19) United States
(12) Patent Application Publication
(10) Pub. No.: US 2024/0183486 A1
(43) Pub. Date: Jun. 6, 2024

(54) CHAMELEON-EYES GIMBAL SYSTEM (CAMEO GIMBAL SYSTEM) AND METHOD OF MANUFACTURING AND USING THE SAME

(71) Applicant: QUOC VIET LUONG, Castro Valley, CA (US)

(72) Inventor: QUOC VIET LUONG, Castro Valley, CA (US)

(21) Appl. No.: 18/460,668

(22) Filed: Sep. 4, 2023

Related U.S. Application Data
(63) Continuation-in-part of application No. 18/061,462, filed on Dec. 4, 2022, now Pat. No. 11,898,690.

(51) Int. Cl. F16M 11/20; F16M 11/10; G03B 17/56; H04N 23/695

(52) U.S. Cl. CPC F16M 11/205; F16M 11/10; G03B 17/561; H04N 23/695

(57) ABSTRACT

A method and a chameleon's eyes like gimbal system (“cameo gimbal system”) are provided which comprises: a first arcuate gimbal arm and a second arcuate gimbal arm mechanically respectively coupled underneath two opposite ends of a pair of square L-shaped gimbal arms. The pair of square L-shaped gimbal arms is coupled to a suspension arm and to a moving object. A pair of payloads are coupled to the first and second arcuate gimbal arms in a manner that allows the payloads to operate independently in a binocular mode and a monocular mode—which are controlled by artificial intelligence based (AI-based) a microprocessor.

### CLAIM OF PRIORITY

This application is a continuation-in-part application under 35 U.S.C. § 120 of application Ser. No. 18/061,462, entitled “Spherical Field of View (FOV) Multiple Payloads Gimbal System and Method of Manufacturing the Same”, by Quoc V. Luong, filed on Dec. 4, 2022. The parent application is incorporated herewith in its entirety for references.

### FIELD OF THE INVENTION

The present invention relates generally to the field of auto tracking gimbals.

More specifically, the present invention relates to a system of multiple auto tracking smart gimbals with unhindered field of view (FOV).

### BACKGROUND OF THE INVENTION

Auto tracking gimbals are used ubiquitously in aerospace, civilian, and military applications. In military applications, gimbals are used to guide missiles, to fly unmanned aerial vehicles (UAV), to guide precise weapons, and to control airborne tactical surveillance. In aerospace, gimbals are used in navigation systems and instrument panels. National Aeronautics and Space Administration (NASA) has been using gimbals in almost every program including the Apollo, Gemini, and all other space exploration missions. In civilian or industrial applications, gimbals are used to stabilize cameras and navigation equipment in aerial photogrammetry and videography.

FIG. 1 illustrates the operating principles and limitations of a common prior-art 3-axis gimbal 100 (“prior-art gimbal 100”). In general, prior-art gimbal 100 has a limited field of view (FOV) due to their inherent designs. Structurally, prior-art gimbal 100 includes a first gimbal frame (yaw) 101, a second gimbal frame (roll) 111, and a third gimbal frame (pitch) 120, all rotatably coupled together. First gimbal frame 101 further includes a position adjustment slot 102, a yaw motor 103, a first rotatable ball screw nut 104 controllably rotated by yaw motor 103. Second gimbal frame 111 is a U-shaped frame that includes a second position adjustment slot 112, a roll motor 113, and a second rotatable ball screw nut 114 connected to the bottom end of first gimbal frame 101. Third gimbal frame 120 is designed to support a camera payload (not shown). Third gimbal frame 120 is a rectangular frame that includes a bottom horizontal bar 121 with a payload lock 127, a pair of vertical supports 122-123 with height adjusting screws 125-126 respectively, and a top horizontal bar 124. The entire third gimbal frame 120 is tilted by virtue of a pitch motor 128. Other electrical components such as inertia measurement unit (IMU), gimbal control unit (GCU), and batteries are not shown in FIG. 1.

In operations, prior-art gimbal 100 is panned 360° on a XY plane 131 around the Z-axis of a Cartesian coordinate system 199 because of yaw motor 103. Prior-art gimbal 100 is also barrel rolled 360° on a YZ plane 132 around the X-axis by roll motor 113. Finally, prior-art gimbal 100 is tilted up and down only 180° on a XZ plane 133 around the Y-axis. The geometry of second gimbal frame 111 blocks the rear view of the payload (not shown). In addition, prior-art gimbal 100 can only accommodate one camera. Adjustment slots 102, 112, 125, and 126 are used to adjust the central of gravity of the payload to be coincided to that of gimbal structure consisting of three frames 101, 111, and 120. The operations of inertia measurement unit (IMU) and gimbal control unit (GCU) for prior-art gimbal 100 are well-known in the related arts and thus will not be discussed in details. In other commercially available gimbals such as DJI Inspire 1, Walkera Voyage 3, the retractable arms allow these models to pan 360°. In actuality, they can only roll around +15/−15° and tilt −90 to 15°. Furthermore, prior-art gimbal 100 is not a smart gimbal that can intelligently make decisions based on artificial intelligent algorithms.

Next referring to FIG. 2, a three-dimensional (3D) perspective diagram of a dual payload spherical field of view gimbal 200 (“hereinafter referred to as ‘gimbal lock system 200’) disclosed in the parent patent application Ser. No. 18/061,462 entitled, “Spherical Field of View (FOV) Multiple Payloads Gimbal System and Method of Manufacturing the Same” by the present inventor, filed on Dec. 4, 2022) is disclosed. Gimbal lock system 200 includes many novel improvements over the prior-art gimbal 100 such as multiple cameras, each with 360° unhindered field of view. However, the field of views of cameras are still blocked or limited by suspension frame, first section, and third section respectively. In addition, gimbal lock system 200 cannot operate in different modes like the eyes of the chameleon.

Therefore, what is needed is novel design for gimbals that have unlimited field of view (FOV) in all yaw, roll, and tilt axes that are unhindered by the mechanical frames such as suspension frame 201 and first section 211, and third section 221.

What is needed is a gimbal system that operates in different modes like the eyes of the chameleons.

What is needed is a gimbal system that can intelligently make decisions based on artificial intelligence (AI) based procedures.

What is needed is a method for constructing a gimbal system that can operate in a binocular mode (conjugate mode or synchronous mode) to achieve a common objective and in a monocular mode (disconjugate mode or asynchronous mode) to achieve different objectives.

What is needed is a method for achieving lock or auto tracking with unrestricted field of view (FOV) for a gimbal system.

What is needed is a method for assigning the same and/or different tasks to different cameras mounted on the chameleon-like gimbal system.

The gimbal system and method of the present invention meet the above needs and solve the above problems.

### SUMMARY OF THE INVENTION

Accordingly, an object of the present invention is to provide a method and a cameo gimbal system (“cameo gimbal”) are provided which comprises: a first arcuate gimbal arm and a second arcuate gimbal arm mechanically respectively coupled underneath two opposite ends of a pair of square L-shaped gimbal arms. The pair of square L-shaped gimbal arms is coupled to a suspension arm and to a moving object. A pair of payloads are coupled to the first and second arcuate gimbal arms in a manner that allows the payloads to operate independently in a binocular mode and a monocular mode—which are controlled by an artificial intelligence based (AI-based) microprocessor.

Another object of the present invention is to provide a method for obtaining a cameo gimbal that operates like the eyes of the chameleons each having unhindered 360° field of views.

Another object of the present invention is to provide an intelligent chameleon eyes like gimbal system that is controlled by AI-based algorithms.

Another object of the present invention is to provide a method and a cameo gimbal for carrying multiple payloads without visual restrictions.

These and other advantages of the present invention will no doubt become obvious to those of ordinary skill in the art after having read the following detailed description of the preferred embodiments, which are illustrated in the various drawing and figures.

### BRIEF DESCRIPTION OF DRAWINGS

The accompanying drawings, which are incorporated in and form a part of this specification, illustrate embodiments of the invention and, together with the description, serve to explain the principles of the invention.

FIG. 1 is a prior-art three-axis gimbal device that expresses limited yaw field of view due to its geometrical design;

FIG. 2 is a three-dimension (3D) perspective diagram of a dual payload gimbal lock system previously invented by the inventor;

FIG. 3 is a three-dimension (3D) perspective diagram of a chameleon-eyes (cameo) gimbal structure in accordance with an exemplary embodiment of the present invention;

FIG. 4 is a 3D assembly diagram showing the layout of different components of the cameo gimbal structure in accordance with an exemplary embodiment of the present invention;

FIG. 5 is an assembly diagram of the dual payload gimbal system in accordance with an aspect of the present invention;

FIG. 6 shows an example of the monocular (disconjugate or asynchronous) mode of the cameo gimbal structure where the first camera and the second camera operate independently in accordance with an embodiment of the present invention;

FIG. 7 shows a binocular (conjugate or synchronous) mode of the cameo gimbal system where the first camera and the second camera operate jointly in accordance with an embodiment of the present invention;

FIG. 8 illustrates a schematic diagram of the electrical components of the cameo gimbal system in accordance with an exemplary embodiment of the present invention;

FIG. 9 illustrates the layout of the cameo gimbal system in accordance with an exemplary embodiment of the present invention;

FIG. 10 illustrates a schematic diagram of the entire network of the cameo gimbal system in accordance with an exemplary embodiment of the present invention;

FIG. 11 illustrates a flow chart of a method of constructing the cameo gimbal system in accordance with an exemplary embodiment of the present invention;

FIG. 12 illustrates a flow chart of a method of operating cameo gimbal system in accordance with an exemplary embodiment of the present invention;

FIG. 13 illustrates a construction inspection application of the cameo gimbal system in accordance with an exemplary embodiment of the present invention; and

FIG. 14 illustrates a structure inspection and photography applications using the cameo gimbal system in accordance with an exemplary embodiment of the present invention.

The figures depict various embodiments of the technology for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, and components have not been described in detail so as not to unnecessarily obscure aspects of the present invention.

Within the scope of the present description, the terms “conjugate mode” or “synchronous mode” or “binocular mode” means to operate together to achieve one common objective regardless of the field of view (FOV) directions of each device. The term “disconjugate mode” or “asynchronous mode” or “monocular mode” means to operate separately to achieve different objectives regardless of the field of view (FOV) directions of each device.

Within the scope of the present description, the reference to “an embodiment” or “the embodiment” or “some embodiments” means that a particular feature, structure or element described with reference to an embodiment is comprised in at least one embodiment of the described object. The sentences “in an embodiment” or “in the embodiment” or “in some embodiments” in the description do not therefore necessarily refer to the same embodiment or embodiments. The particular features, structures, or elements can be furthermore combined in any adequate way in one or more embodiments.

Within the scope of the present description, the word “drones” include different forms of unmanned flying targets including unmanned aerial vehicles (UAV), drones with propellers affixed at different locations on the drones.

Within the scope of the present description, the words “coupling”, “connecting”, “coupled”, “coupling”, “connections”, “bolted”, “laid”, “positioned”, “attached”, “attaching”, “affixed”, “affixing” are used to mean attaching between two described members using screws, nails, tongs, prongs, clips, spikes, staples, pins, male and female nuts, buttons, sleeves, lugs, cams, handles, bars, fasteners, connectors, 3D gimbals, or the likes.

Within the scope of the present description, the words “remote control”, “remote controlling” are used to mean wired and/or wireless controlling. Wired connections include electrically conducting wires, cables, lines, coaxial cables, strips, or the likes. Conducting wires are made of conductors such as coppers, aluminum, gold, or the likes. Wireless connections include electromagnetic waves, cellular network such as GSM, GPRS, WCDMA, HSPA, and LTE, 4G, 5G, etc., IEEE 802.15.4, IEEE 802.22, ISA100a, wireless USB, and Infrared (IR), LoRa devices, etc. Medium range wireless communication channels in this embodiment of communication link 161 include Wi-fi and Hotspot. Long range wireless communication channels include UHF/VHF radio frequencies.

Within the scope of the present description, the word “network” includes data center, cloud network, or network such as nano network, body area network (BAN), personal area network (PAN), local area network (LAN), campus/corporate area network (CAN), metropolitan area network (MAN), wide area network (WAN), mesh area networks, edge or regional data center, core network, cloud, or any combinations thereof.

Within the scope of the present description, the word “rotation”, “rotating”, or “rotate” includes clockwise and/or counterclockwise direction.

Within the scope of the present invention, the Cartesian XYZ coordinate (x,y,z) also includes equivalent spherical coordinate (r, θ, Φ), and/or cylindrical coordinate (r, θ, z) that can determine the directions of movements or coordinates of the enemy's targets including GPS coordinates.

Within the scope of the present description, the word targets refer to the enemy's tanks, armored vehicles, military transportation means, trucks, ships, troops, bunkers, buildings, tents, airports, and aircrafts on the ground, the enemy's ground missile launchers, or the likes.

Within the scope of the present description, the word payloads refer to RGB cameras, heat sensors, infrared sensors, light-emitting depth cameras, light-field cameras, event-based cameras, magnetic, olfaction, thermal sensors, dipole, Lidar, or the likes.

Within the scope of the present description, the word movable objects refer to drones, unmanned aerial vehicles (UAV), aircraft, ground transportation, such as cars and trucks, humans, selfie-stick, or the likes.

Within the scope of the present description, the same components are referred to different reference numerals in different FIGS. Table 1 lists all components that have different reference numerals but they are the same in different FIGS. The inclusion of Table 1 is to avoid confusion.

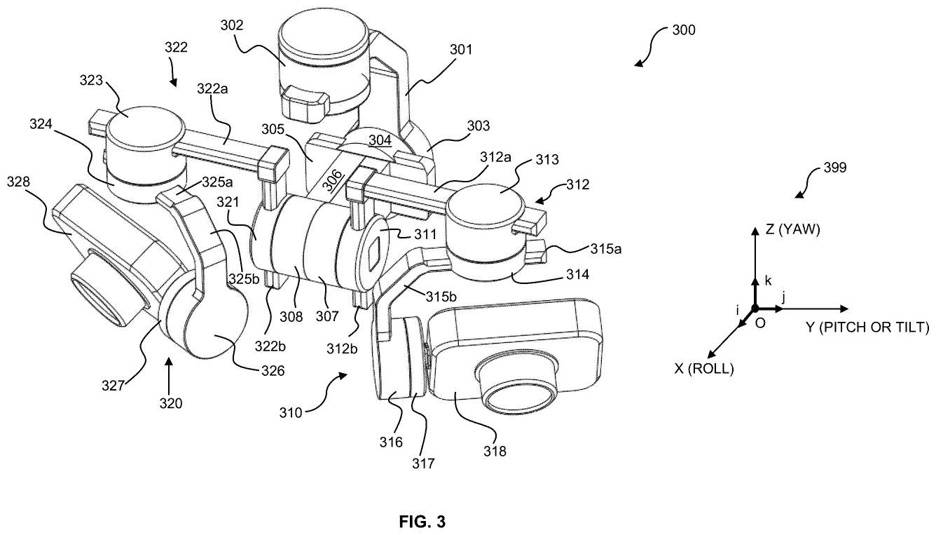

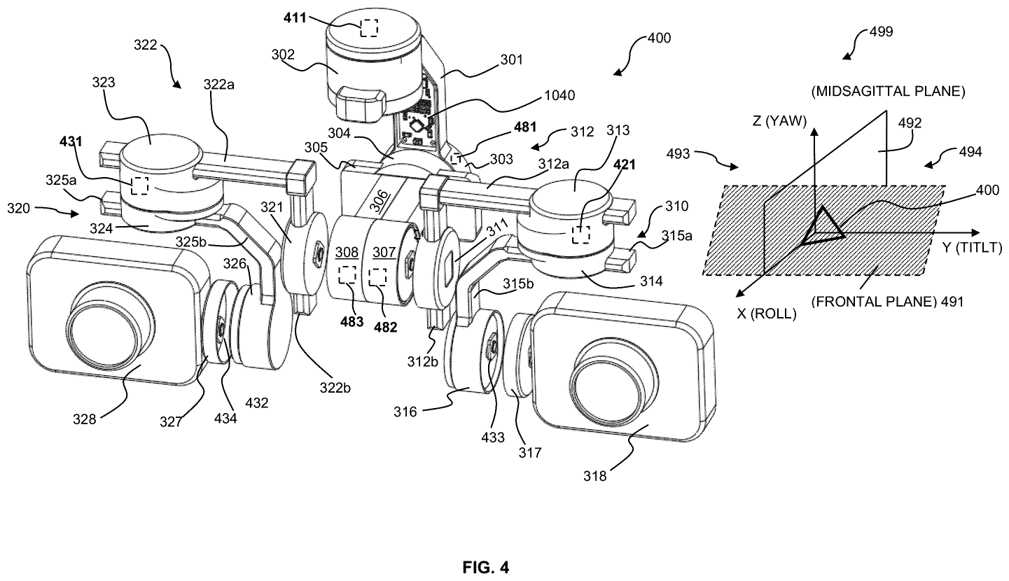

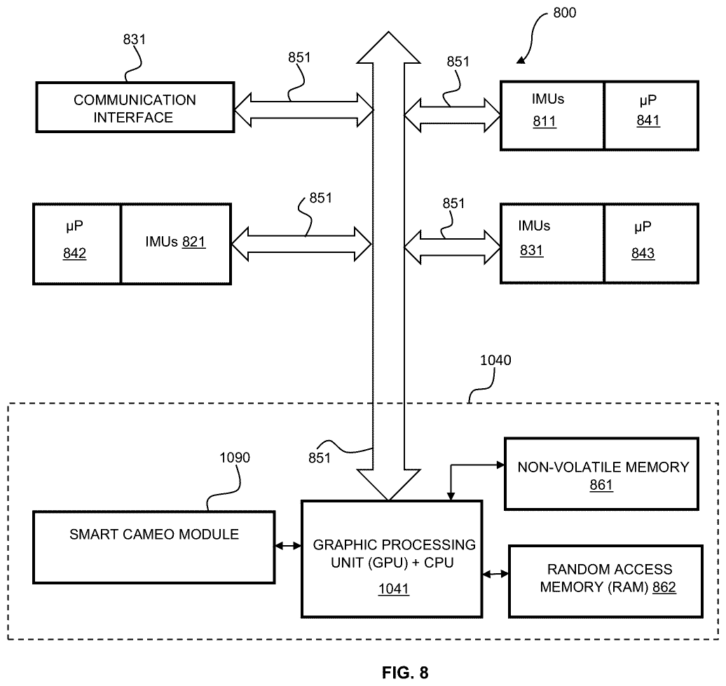

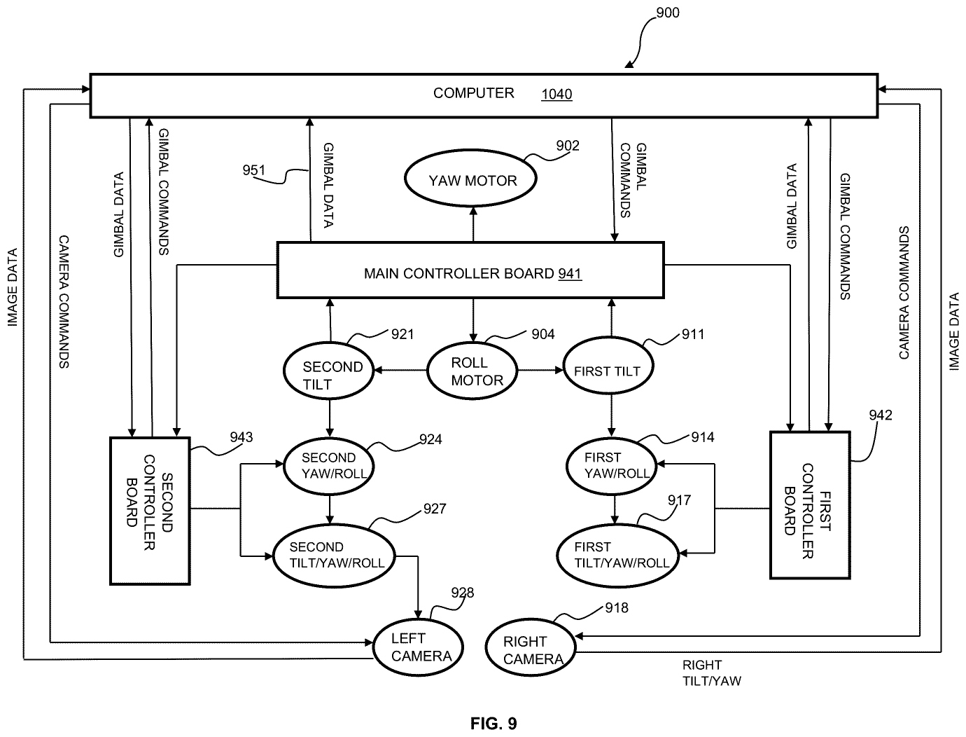

TABLE 1
List of Same Components that that
Have Different Reference Numerals

| | | | |
|---|---|---|---|
| IMU in FIG. 4 | 431 | 432 | 433 |
| IMU in FIG. 8 | 811 | 821 | 831 |
| Rotors in FIG. 3 | Main yaw rotor | First tilt rotor | Second tilt rotor |
| | 302, main roll | 311 and | 321; Second |
| | rotor 304 | First roll/yaw | roll/yaw 324 |
| | | rotor 314 | Second |
| | | First tilt/yaw/ | tilt/yaw/roll rotor |
| | | roll rotor 317 | 327 |
| Rotors in FIG. 9 | Yaw rotor 902, | First tilt rotor | First tilt rotor |
| | roll rotor 904 | 911 and | 921 and |
| | | First roll/yaw | First roll/yaw |
| | | rotor 914 | rotor 924 |
| | | First tilt/yaw/ | First tilt/yaw/ |
| | | roll rotor 917 | roll rotor 927 |
| Controller boards | 481 | 482 | 483 |
| in FIG. 4 | | | |
| Controller Boards | 841 | 842 | 843 |
| in FIG. 8 | | | |
| Microprocessors | 941 | 942 | 943 |
| in FIG. 9 | | | |

It should be noted that throughout the specification and claims herein, when one element is said to be “coupled' or “connected to another, this does not necessarily mean that one element is fastened, secured, or otherwise attached to another element. Instead, the term “coupled or “connected means that one element is either connected directly or indirectly to other elements or is in mechanical or electrical communication with other elements.

Referring now to the drawings and specifically to FIG. 3, a three-dimensional (3D) perspective diagram of a chameleon eyes gimbal system 300 (hereinafter referred to as ‘cameo gimbal system 300’) in accordance with an exemplary embodiment of the present invention is illustrated. Mechanically, cameo gimbal system 300 includes a curved suspension arm 301, a firs square L-shaped gimbal arm 312, a first arcuate arm 310, a second square L-shaped gimbal arm 321, and a second arcuate arm 320. The proximate terminal of curved suspension arm 301 is coupled a main yaw rotor 302 which is attached to a movable objects such as drones, UAVs, aircrafts, automobiles, trains, or ships, etc. The distal terminal of curved suspension arm 301 is connected to a first pot connector 303 and a main roll rotor 304. Main roll rotor 304 is attached to a gimbal arm supporting plate 305 which has a rectangular shape. Gimbal arm supporting plate 305 is attached to a thick primary linking arm 306 which protrudes out of the page. In other words, primary linking arm 306 is parallel to the X-axis and protruding out of the page, perpendicular to gimbal arm supporting plate 305. Primary linking arm 306 is coupled to a second pot connector 307 and a third pot connector 308. Second pot connector 307 is coupled to support a first tilt (pitch) rotor 311. First tilt rotor 311 is coupled to a base section 312b of first square L-shaped gimbal arm 312. A top section 312a of first square L-shaped gimbal arm 312 is connected to a fourth pot connector 313. Fourth pot connector 313 is coupled to support a first yaw rotor 314. First yaw rotor 314 is coupled to a top section 315a of arcuate arm 310. A base section 315b of first arcuate gimbal arm 310 is attached to a fifth pot connector 316 and to a first roll rotor 317. First roll rotor 317 is attached to the lateral side of a first camera 318. On the other side of cameo gimbal 300, third pot connector 308 is coupled to support a second pitch rotor 321. Second pitch rotor 321 is coupled to a base section 321b of second square L-shaped gimbal arm 322. A top section 322a of second square L-shaped gimbal arm 322 is connected to a sixth pot connector 323. Sixth pot connector 323 is coupled to support a second yaw rotor 324. Second yaw rotor 324 is coupled to a top section 325a of second arcuate gimbal arm 320. A base section 325b of second arcuate gimbal arm 320 is attached to a seventh pot connector 326 and to a second roll rotor 327. Second roll rotor 327 is attached to the lateral side of a second camera 328. Within the scope of the present invention, the term arcuate means either 2D or 3D curved L-shaped arm which includes a top section and a base section. Square L-shaped arm means that first section and base section forms a 90° angle. Dimensionally, in a fully folded state, cameo gimbal 300 has a length from first camera 318 to second camera 328 of 354 mm, a width from a first pot connector 303 to the front of both cameras 318-328 is 119 mm, and a height from the bottom side of both cameras 318-328 to the top of main yaw rotor 302 is 254 mm.

Continuing with FIG. 3, as disclosed above, cameo gimbal system 300 includes main yaw rotor 302, main roll rotor 304, first tilt rotor 311, first roll rotor 314, first roll rotor 317 on one side of main yaw rotor 302. Second pitch rotor 321, second yaw rotor 324, and second roll rotor 327 on the other side of first pot connector 303. Because of the arrangement of the present invention, first yaw rotor 314 is also known as first yaw/roll rotor 314 because it can roll by main roll rotor 304 and yaw itself. Similarly, first roll rotor 317 is also known as first tilt/yaw/roll rotor 317 because it can yaw and roll by first yaw/roll rotor 314, and tilt by itself. Similarly, second yaw rotor 324 is also known as second yaw/roll rotor 324 because it can roll by main roll rotor 304 and yaw itself. Similarly, second roll rotor 327 is also known as tilt/yaw/roll rotor 327 because it can yaw and roll by main roll rotor 304, and tilt by itself. Imagine, main yaw rotor 302 is the top of a chameleon head, then first tilt rotor 311, first yaw/roll rotor 314, first tilt/yaw/roll rotor 317 are its motors for its right eyes. Second tilt rotor 321, second yaw/roll rotor 324, and second tilt/yaw/roll rotor 327 are the motors for its left eyes. While first roll rotor 304 functions as its head that can roll barrel 360°. In some embodiments of the present invention, rotors 302, 304, 311, 314, 317, 321, 324, and 327 are DC brushless rotors and include rotor controllers and other supporting circuits such as batteries, torque amplification devices such as the K3NG rotors. Each of rotors 302, 304, 311, 314, 317, 321, 324, and 327 outputs a rotational torque proportional to the input voltages they receive. As first tilt/yaw/roll rotor 317 is rolled 360° around the X-axis, first camera 318 scans 360° around the Y-axis and Z-axis, covering 360° field of view below first square L-shaped gimbal arm 312 without being obstructed by curved suspension arm 301. Similarly, as second tilt/yaw/roll rotor 327 is rolled 360° around the X-axis, second camera 328 scans 360° around the Y-axis and Z-axis, covering 360° field of view below second square L-shaped gimbal arm 322 without being obstructed by curved suspension arm 301.

Next referring to FIG. 4, a three-dimensional (3D) perspective diagram of a chameleon eyes gimbal system 400 equipped with inertia measurement units (IMU) and corresponding microprocessors (”hereinafter referred to as ‘cameo gimbal system 400’) in accordance with an exemplary embodiment of the present invention is illustrated. Inertia measurement units (IMUs) are deposited next to rotors 302, 304, 311, 314, 317, 322, 324, and 327 for outputting roll, pitch, and yaw information. The IMUs measure and report specific gravity, velocity, and angular rate of an object to which it is attached. In the present invention, the outputs of IMUs including specific gravity, velocity, and angular rate are referred to as IMU outputs. An IMU typically consists of gyroscopes, magnetometers, accelerometers, and optionally an altimeter. In various embodiments of the present invention, the IMUs used are 3-axis sensors. The microprocessors (controller boards) are placed close to the IMUs and receive the IMU outputs. The microprocessors use these IMU outputs to control the operations of cameo gimbal 400 while those of first camera 318 and second camera 328 are controlled by a separate computer. More particularly, a first IMU 411 is installed next to measure the IMU outputs of main yaw rotor 302. A second IMU 412 is installed next to measure the IMUs outputs of main roll rotor 304. A third IMU 413 is installed next to measure the IMU outputs of first tilt rotor 311. A fourth IMU 421 is installed next to measure the IMU outputs of first yaw/roll rotor 314. A fifth IMU 422 is installed next to measure the IMU outputs of tilt/yaw/roll rotor 317. A sixth IMU 414 is installed next to measure the IMU outputs of second tilt rotor 321. A seventh IMU 431 is installed next to measure the IMU outputs of yaw/roll rotor 324. An eighth IMU 432 is installed next to measure the IMU outputs of second tilt/yaw/roll rotor 327. In many aspects of the present invention, other types of sensors such as GPS/IMU and GPS/Inertia Navigation System (INS) may be placed on cameo gimbal 400 to assist in the stabilizing operations and operations of cameo gimbal 400. IMUs 411, 412, 413, 414, 421, 422, 431, and 433 measure the three-axis attitude angle (or angular velocity) and acceleration of an object. Generally, an IMU contains three single-axis accelerometers and three single-axis gyroscopes (“gyros”). The accelerometers detect the acceleration signals of payloads (not shown, please refer to FIG. 3) in NED coordinate system 399 independent of cameo gimbal 400. The gyros detect the angular velocity signals of the carrier relative to the navigation coordinate system, measure the angular velocity and acceleration of the object in three-dimensional space, and solve the attitude of the object. IMUs are well known in the art and need not to be described in detail in the present invention. IMUs can be purchased from manufacturers such as ADI (Part Number ADIS16480BMLZ), Bosch (Part Number BMI160), STMcroelectronics, (Part Number LSM9DS1TR), TDK InvenSense (Part Number IAM-20680), and Murata (Part Number SCC2230-D08-05), or VectorNAV® VN100 or VN110.

Continuing again with FIG. 4, an earth-bound reference Cartesian coordinate system 499 is a fixed NED (North East Down) reference system used in the present invention to keep track of the positions of the moving targets (not shown) when cameo gimbal 400 is moved with a movable object. NED reference coordinate system 499 includes an x-axis also known within the related art as the roll axis, a y-axis known as the pitch axis, and a z-axis known as the yaw axis. The x-axis has a unit vector \vec{i}, the y-axis has a \vec{j} unit vector, and the z-axis has a \vec{k} unit vector. A frontal plane 491 coincides with the XY plane that contains a drone that carries cameo gimbal system 400. A midsagittal plane 492 coincides with the XZ plane that divides cameo gimbal system 400 into a left half space 493 and a right half space 494. First microprocessor (μP) 481 is placed close to first IMU 411 to control main yaw rotor 302 and main roll rotor 304. Second uP 482 is placed close to second IMU 421 to control first tilt rotor 311, first yaw/roll rotor 314, and first tilt/yaw/roll rotor 317. Third μP 483 is placed close to third IMU 431 to control second yaw/roll rotor 324, second yaw/roll rotor 324, and second tilt/yaw/roll rotor 327. The IMU outputs are translated to reference coordinate system 499 to dynamically adjust cameo gimbal 400 to achieve payload spatial positioning that is capable of tracking multiple of targets (not shown). An onboard computer 1040 is artificial intelligence based (AI-based) that receives information from IMUs 411, 421 431, and microprocessors 481-483 to control first camera 318 and second camera 328.

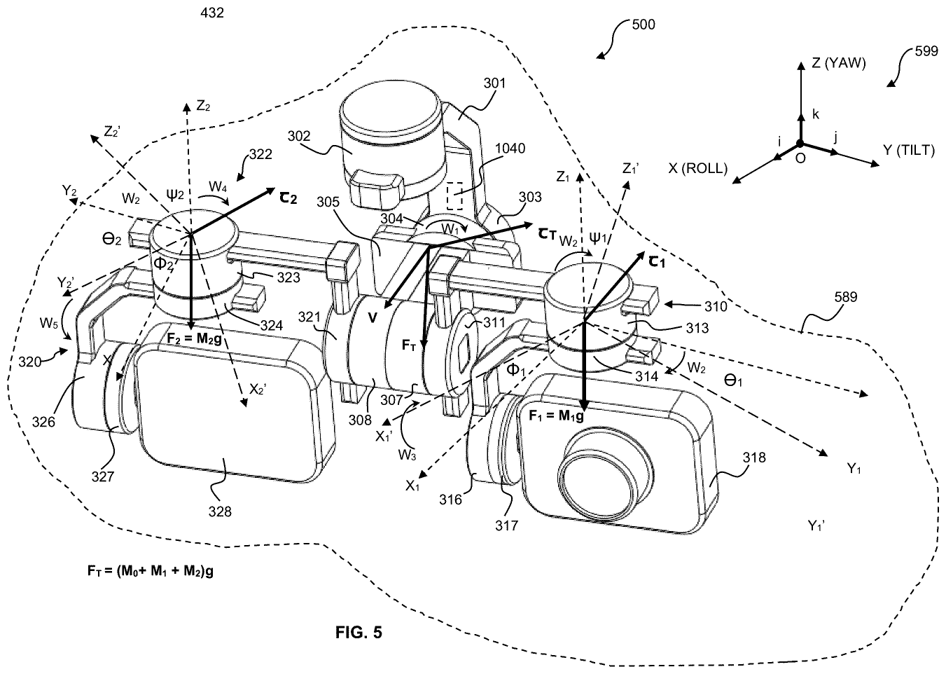

Next referring to FIG. 5, a perspective diagram illustrating the external force analyses of a cameo gimbal system 500 equipped with dual cameras as payloads in accordance with an exemplary embodiment of the present invention is shown. Cameo gimbal system 500 includes first camera 318 mounted on first arcuate arm 310 and second camera 328 mounted on second arcuate arm 320. To illustrate the working principle of cameo gimbal system 500 of the present invention, assume cameo gimbal system 500 is moving forward with a velocity V. First camera 318 and first arcuate arm 310 have a mass M₁; second camera 328 and second arcuate arm 320 have a mass M₂. Curved suspension arm 301 and primary linking arm 306 have a total mass M₀. Main yaw rotor 302. main roll rotor 304, first tilt rotor 311, second tilt rotor 321, first yaw/roll rotor 314, second yaw/roll rotor 324, first tilt/yaw/roll rotor 317, and second tilt/yaw/roll rotor 327 are freely rotated with respect to a reference Cartesian coordinate 599 which is an earth bound NED Cartesian Coordinate System that causes first camera 318 to rotate at Euler angles Φ1, θ1, and ψ1 with respect to a first local reference coordinate X₁Y₁Z₁. At the same time, second camera 328 rotates at Euler angles Φ2, θ2, and ψ2 with respect to a second local reference coordinate X₂Y₂Z₂.

Continuing with FIG. 5, a total gravity force Fg=(M₀+M₁+M₂)g exists at the center of gravity of cameo gimbal system 500. As the whole cameo gimbal system 500 rotates, a total torque [symbol] _{T} exists comprising a drag force F_{d} due to the velocity V, forces due to the rotations of main yaw rotor 302, main roll rotor 304, first tilt rotor 311, second tilt rotor 321, first yaw/roll rotor 314, second yaw/roll rotor 324, first tilt/yaw/roll rotor 317, second tilt/yaw/roll rotor 327, first camera 318, and second camera 328. Alternatively, first camera 318 experiences a gravitational force F₁=M₁g and a torque [symbol] ₁ composed of rotation of main yaw rotor 302, main roll rotor 304, second tilt rotor 321, second yaw/roll rotor 324, second tilt/yaw/roll rotor 327 and those of second camera 328. Similarly, second camera 328 experiences a gravitational force F₂=M₂g and a torque [symbol] ₂ composed of rotation of main yaw rotor 302, main roll rotor 304, first tilt rotor 311, first yaw/roll rotor 314, first tilt/yaw/roll rotor 317 and those of second camera 328.

These forces F_{T}, F₁, F₂, [symbol] _{T}, [symbol] ₁, [symbol] ₂ tend to cause cameo gimbal system 500 to deviate by an error Euler angle amounts of (ΔΦ₁, Δθ₁, and Δψ₁) in first camera 318 and (ΔΦ₂, Δθ₂, and Δψ₂) in second camera 328. The actual rotation angle for first camera 318 is by an Euler angle of Φ₁+ΔΦ₁, θ₁+Δθ₁, and ψ₁+Δψ₁. The actual rotation angle for second payload 328 is by an Euler angle of Φ₂+ΔΦ₂, θ₂₁+Δθ₂, and ψ₂+Δψ₂. These Euler angle errors can be calculated by multiplying the preset rotation matrix with the inverse of the actual rotation matrix.

In practice, microprocessors 481-483 receive respective IMU outputs of IMU sensors 431-433 to measure the Euler angle differences between the actual and the preset angles. Then, microprocessors 481, 482, and 483 convert these errors in Euler angles to voltages which are used to adjust the rotation of first camera 318 and second camera 328. It is noted that high frequency vibrations affecting cameo gimbal system 500 are not considered within the present invention but they can be significantly dampened using 3D printed anti-vibration platform, O-ring suspension mount, ear plug mount, and bulb damper. These types of anti-vibrational dampeners can eliminates high-frequency vibrations. Other errors caused by moving targets can be corrected by phase interferometry method or direction finding (DF) techniques by the movable object which is equipped with cameo gimbal system 500. Therefore, rotational errors caused by the movements of the targets are not considered herewith. Another type of errors including the centrifugal forces that cause rotor imbalance can be cured by calibration procedure before use.

Continuing with FIG. 5, a rotation around a single x-axis of first camera 318 by an Euler angle Φ₁ is represented by a rotation matrix:

$$⌈ \begin{matrix}1 & 0 & 0 \\ 0 & cos Φ1 & - sin Φ1 \\ 0 & sin Φ1 & cos Φ1\end{matrix} ⌉$$

The rotation around y-axis of first camera 318 by an Euler angle θ₁ is represented by a rotation matrix:

$$\\ ⌈ \begin{matrix}cos θ 1 & 0 & sin θ 1 \\ 0 & 1 & 0 \\ - sin θ 1 & 0 & cos θ 1\end{matrix} ⌉$$

The rotation around the z-axis of first camera 318 by an Euler angle ψ₁ is represented by a rotation matrix:

$$\\ ⌈ \begin{matrix}cos ψ 1 & - sin ψ 1 & 0 \\ sin ψ 1 & cos ψ 1 & 0 \\ 0 & 0 & 1\end{matrix} ⌉$$

Together, when all three arbitrary rotations happen at the same time in the XYZ axis can be represented by multiplying the above rotation matrices together to obtain the total rotation matrix:

$$\\ ⌈ \begin{matrix}cos Φ 1 cos θ 1 cos ψ 1 - sin Φ 1 sin ψ 1 & - cos ψ 1 sin Φ 1 - cos Φ 1 cos θ 1 sin ψ 1 & cos Φ 1 sin θ 1 \\ cos θ 1 cos ψ 1 sin Φ 1 + cos Φ 1 sin ψ 1 & cos ψ 1 cos ψ 1 - cos θ 1 sin Φ 1 sin ψ 1 & sin Φ 1 sin θ 1 \\ - cos ψ 1 sin θ 1 & sin θ 1 sin ψ 1 & cos θ 1\end{matrix} ⌉$$

Let this total rotation matrix around XYZ axis be represented by R_{T}(Φ₁, θ₁, ψ₁). When an error occurs due to the external forces discussed above, the actual total rotation matrix is denoted as [symbol] (Φ₁+ΔΦ₁, θ₁+Δθ₁, ψ₁+Δψ₁) obtained by measuring the actual total rotation using first, second, and third IMUs 431, 432, 433. The error in Euler angles Rₑ=R_{T}× [symbol] _{T}, where Rₑ=(Δθ₁, ψ₁, Δψ₁) and [symbol] is the transpose of [symbol] (Φ₁+ΔΦ₁, θ₁+Δθ₁, ψ₁+Δψ₁). The Euler angle differences or errors Rₑ are converted to voltages. Microprocessors 481-483 use these voltages as correcting signals to re-orient first camera 318.

Continuing with FIG. 5, in terms of quaternion, let Q₁=(w₁, \vec{r₁}) be the quaternion transformation of the total rotation of the R_{T}(Φ₁, θ₁, ψ₁) above and [symbol] =(w₂, [symbol] ) be the quaternion transformation of the total actual rotation matrix [symbol] (Φ₁+ΔΦ₁, θ₁+Δθ₁, ψ₁+Δψ₁). Where \vec{r₁}=(a₁\vec{i}+b₁\vec{j}+c₁\vec{k}) and \vec{r₂}=(a₂\vec{i}+b₂\vec{j}+c₂\vec{k}). The errors between two quaternions can be detected using first, second, and third IMU 411, 421, and 331 and/or other sensors such as GPS. Then, these error signals can be computed by Qₑ= [symbol] ⁻¹×Q₁, where Qₑ is the error quaternion and [symbol] ⁻¹ is the inverse of the actual rotation quaternion. Then Qₑ is converted into correcting voltages transmitted respective microprocessors 481, 482, 483 to position first arcuate arm 310 and second arcuate arm 320. The correction positions include tracking positions of targets or free rotating payloads without losing any degrees of freedom (DOF). In the earlier situation, the movable object may move in a first direction while first camera 318 and second camera 328 are tracking the targets. In latter situation, the movable object may lock into the targets while first camera 318 and second camera 328 are free to rotate without being locked up to incorrect positions.

It is noted that either Euler matrices or quaternion methods described above are mutable. That is, the Euler matrices can be converted to quaternion method and vice versa. Furthermore, the analyses of second camera 328 are the same as those of first camera 318. That is, (1) measuring all forces that affect second camera 328; (2) measuring the actual angles affected by these forces; (3) measuring the errors between preset angles and the actual angles; (4) Using the errors to re-position second camera 328.

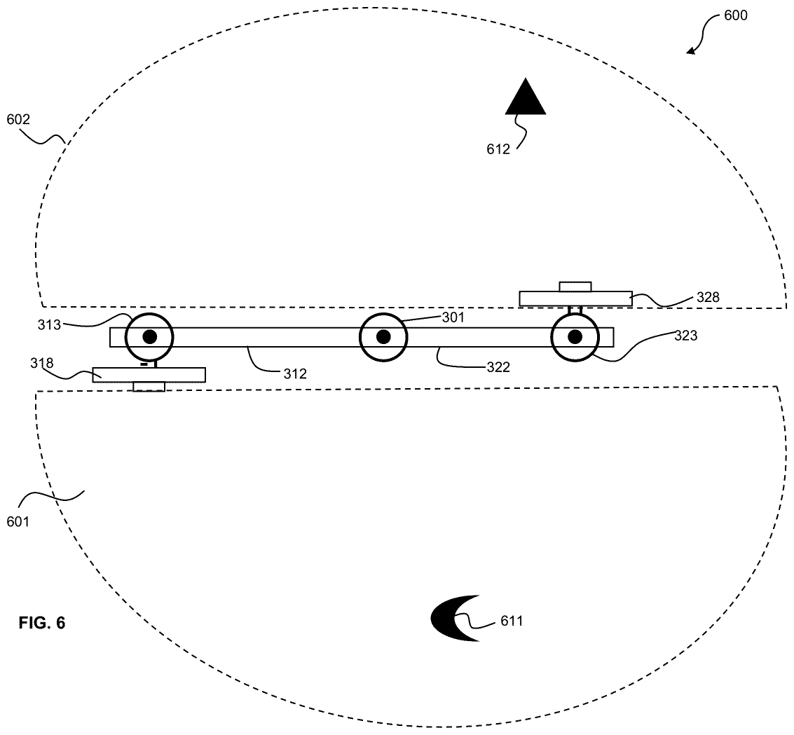

Next, referring to FIG. 6, perspective diagram 600 illustrating an operation of the cameo gimbal system in accordance with an aspect of the present invention is presented. Diagram 600 is an exemplary orientation of cameo gimbal system 400 in which first camera 318 and second camera 328 scan in opposite directions. In the monocular mode, under the supervision of onboard computer 1040, each camera 318/328 is operating independently to achieve independent and separate objectives, regardless of their respective directions. As illustrated in FIG. 6, first camera 318 is scanning 180° with an unobstructed field of view 601 to the bottom of the paper to achieve a first function. Taking FOV 601 into account, onboard computer 1040 directs second camera 328 to achieve a second function different from the first function in a field of view 602 pointing toward the top of FIG. 6. An exemplary but non-limiting scenario, the first function of searching and taking picture of a first target 611 is assigned to first camera 318 by onboard computer 1040. The second function of videoing a second target is assigned to second camera 328 by on board computer 1040. Onboard computer 1040 uses its artificial intelligence algorithms and modules to assign appropriate tasks to first camera 318 and second camera 328 so as to achieve independent results. It is noted that even when FOV 601 and FOV 602 are directed to the same direction, first camera 318 and second camera 328 are still in monocular mode because they are carrying out different and independent functions. In the binocular mode, under the supervision of onboard computer 1040, each camera 318/328 is operating jointly to achieve a common objective, regardless of their respective directions. As illustrated in FIG. 6, first camera 318 is scanning 180° with an unobstructed field of view 601 to the bottom of the paper to achieve a first function. Taking FOV 601 into account, onboard computer 1040 directs second camera 328 to achieve the same and jointly function with first camera 318 in a field of view 602 pointing toward the top of FIG. 6. An exemplary but non-limiting scenario, the first function of searching for a friendly aircraft 611 is assigned to first camera 318 by onboard computer 1040. The second function of searching for the same friendly aircraft 611 is assigned to second camera 328 by on board computer 1040. Onboard computer 1040 uses its artificial intelligence algorithms and modules to assign appropriate tasks to first camera 318 and second camera 328 so as to achieve independent results. It is noted that even when FOV 601 and FOV 602 are directed to the same direction, first camera 318 and second camera 328 can still operate in binocular mode because they are carrying out joint functions (i.e., of searching for friendly aircraft 611). It is noted that because of this binocular mode, the enemy aircraft is detected faster than that of the prior-art gimbals. That is, without first camera 318 operating in binocular mode, second camera 328 can only see enemy aircraft 612.

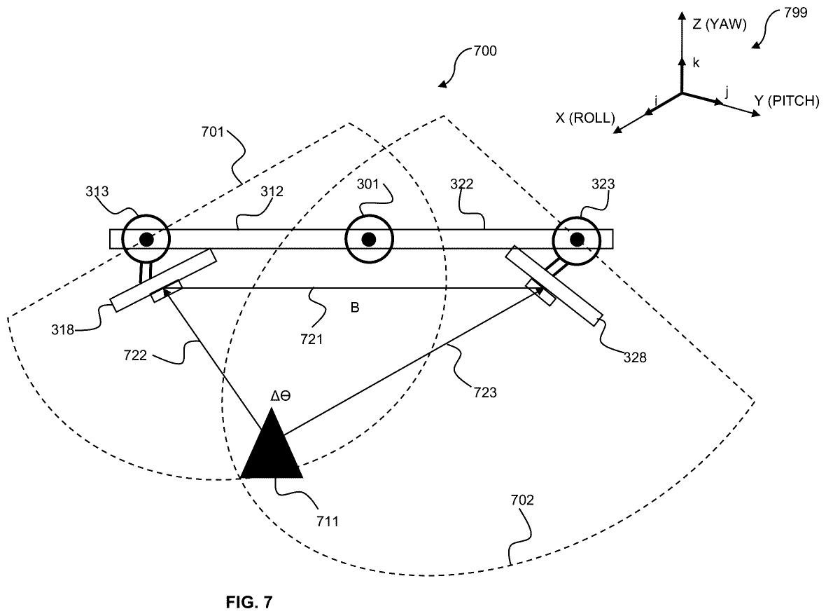

Next referring to FIG. 7, perspective diagram 700 illustrating operations of the cameo gimbal system in accordance with an aspect of the present invention is presented. Diagram 700 is an exemplary orientation of cameo gimbal system 400 in which first camera 318 and second camera 328 scan in the same direction. In the binocular mode, each camera 318/328 is looking independently at either he same directions and/or different directions under the supervision of onboard computer 1040 to achieve the same objective. As illustrated in FIG. 7, first camera 318 is scanning 360° with an unobstructed field of view 701. Taking FOV 701 into account and the location of a target 711, onboard 1040 directs second camera 328 to point to the same direction in a field of view 702 overlapping with FOV 701. As seen, the exact location of target 711 can be determined using the phase interferometry method. In the phase interferometry, the phase difference of signals traveling between a first distance (signal path) 722 between target 711 and first camera 318 and a signal traveling between second distance (signal path) 723 between target 711 and second camera 328. If the signal received by first camera 318 is A₀ sin(wt) (Equation 1) and the signal received by second camera 328 is A₀ sin(wt+ø) where Φ is the phase different between signal paths 722 and 723.

The product of the two signals is:

$${A}_{0} sin ( wt ) \cdot {A}_{0} sin ( wt + ∅ ) = \frac{1}{2} {A}_{0}^{2} [ cos ( 2 wt + ∅ ) - cos \frac{1}{2} ∅ ] . \qquad ( Equation 2 ) .$$

Passing the product signal through a low pass filter, the term 2 wt will be filtered out and the phase different Φ is obtained. With the phase difference Φ, the location of target 711 is readily obtained by the formula:

$$\frac{λΔ∅}{2 π} \qquad ( Equation 3 )$$

where λ is the wavelength of the transmitting signal and Ad is the phase difference between the two signal paths 722 and 723. In other aspects of the present invention, target 711 is detected by triangulation between first camera 318, second camera 328, and another sensor located on a NED coordinate system 799.

Continuing with FIG. 6 and FIG. 7, as illustrated above, cameo gimbal system 400 operates like a chameleon eyes. In the monocular mode, onboard computer 1040 commands first camera 318 and second camera 328 of cameo system 400 to operate independently like the chameleon eyes when searching for different preys and looking out for different predators. In the binocular mode, onboard computer 1040 tells first camera 318 and second camera 328 to focus on target 711 and perform jointly. This is similar to the situation where the chameleon detects a grasshopper in front of it. Referring back to FIG. 4, in the binocular mode, second yaw/roll rotor 324 can rotate clockwise and second tilt rotor 321 can turn counterclockwise to put first camera 318 in front of second camera 328 as first camera 318 and second camera 328 are looking in the same direction. In-depth detection of target 711 is achieved, similar to the eyes of the chameleon.

With the monocular mode or bipolar mode of operations described in FIG. 6 and FIG. 7, cameo gimbal 400 of the present application achieves efficiency in various industrial applications such as:
(1) topographic mapping and land surveys: in monocular mode or binocular mode selected by onboard computer 1040, first camera 318 and second camera 328 can photograph different swathes of lands and then a software stich these maps into 3D models;
(2) equipment tracking: in monocular mode or binocular mode selected by onboard computer 1040, first camera 318 and second camera 328 keep tracks of each equipment's location on a job site, recording errors and locations;
(3) using artificial intelligence algorithms and modules, onboard computer 1040 mounted on cameo gimbal 400 can guide first camera 318 and second camera 328 to perform different tasks controlling two different construction vehicles working on different swathes of lands.
(4) remote monitoring and progress reports: in monocular mode or binocular mode selected by onboard computer 1040, first camera 318 and second camera 328 can collaborate by capturing real-time data and photos of two different targets and sending back progress reports.
(5) security surveillance: in monocular mode or binocular mode selected by onboard computer 1040, first camera 318 and second camera 328 can check the securities of two different storage of equipment and detect unauthorized individuals to improve site security.
(6) personal safety: in monocular mode or binocular mode selected by onboard computer 1040, cameo gimbal 400 can increase safety by making hard-to-reach or impossible measurements on behalf of workers and monitoring for falls and accidents on two different buildings at the same time.
(7) structure inspection and photography: in monocular mode or binocular mode selected by onboard computer 1040, cameo gimbal 400 inspects and captures conditions of buildings and high-voltage transmission towers, saving time, costs, human lives, and catching issues.

Next referring to FIG. 8, a layout of a cameo gimbal electrical system 800 (cameo electrical system 800) of the cameo gimbal system configured to perform chameleon eyes like operations, optimization and task assignments of the cameo gimbal system in accordance with an exemplary embodiment of the present invention is illustrated. In various aspects of the present invention, cameo electrical system 800 is an inseparable part of cameo gimbal 400 and designed to achieve not only the monocular and binocular mode described in FIG. 6 and FIG. 7 above but also optimization and other AI-based operations. Furthermore, as can be seen later, cameo electrical system 800 is artificial intelligence based, making cameo gimbal 300 of the present invention is an intelligent gimbal with chameleon eyes like operations. Cameo electrical system 800 includes a main controller board 841 responsible for a first IMU 811, a first controller board 842 responsible for a second IMU 821, and a second controller board 833 responsible for a third IMU 831. First IMU 811, second IMU 821, and third IMU 831 receive AI-based instructions from a graphic processing unit (GPU) and central processing unit (CPU) 1041. First IMU 811, second IMU 821, and third IMU 831 operate independently to one another to ensure the monocular mode and binocular mode instructions are performed properly. GPU/CPU 1041 uses AI-based algorithms to intelligently assign tasks to first camera 318 and second camera 328 so as cameo gimbal 400 achieves optimal performance. Thus, three microprocessors 841, 842, and 843 are dedicated to control the general operations including binocular and monocular mode of cameo gimbal 400. More particularly, first IMU 841 is a sensor for main yaw rotor 302 and main roll rotor 304. Second IMU 842 is a sensor for first tilt rotor 311, first yaw/roll rotor 324, and first tilt/yaw/roll rotor 317. Third IMU 843 is a sensor for second yaw rotor 321, second yaw/roll rotor 324, and second tilt/yaw/roll rotor 327. As shown in FIG. 4, IMUs 811, 821, 8312, main controller board 841, first controller board 832, and second controller 833 are placed outside of onboard computer 1040 and they are all connected to one another via a communication bus 851. Inside onboard computer 1040, a non-volatile memory 861 is dedicated to store any updates of the computer program. A random-access memory (RAM) 862 is a memory storage dedicated to store operation data of IMUs 811, 821, and 831. A cameo program product 1090 includes a non-transitory computer program codes and machine learning software programs to perform intelligent operations of cameo gimbal system 400. When these programs are executed by GPU/CPU 1041, intelligent decisions are issued to assign tasks and either monocular mode or binocular mode to achieve optimal performances cameo gimbal system 400.

Now referring to FIG. 9, a schematic diagram of a cameo gimbal electronic system 900 (system 900) in accordance with an exemplary embodiment of the present invention is illustrated. Cameo gimbal electronic system 900 is responsible for the entire mechanic electronic operations of cameo gimbal system 400. System 900 includes a computer 1040 in communication with cameo gimbal system 400 via a communication link 951. Computer 1040 is located on curved suspension arm 301 and configured to control cameo gimbal system 400 and its movable object (not shown). In various embodiments of the present invention, the movable object may be—but not limited to—a drone, an aircraft, a ship, a train, or a vehicle. On cameo gimbal system 400, system 900 includes computer 1040, a yaw motor 902, a main controller board 941 configured to control a yaw motor 902, roll rotor 904, a first tilt rotor 911, and a second tilt rotor 921, a roll rotor 904, and a second tilt rotor 911. A first controller board 942 is designed to controller a first yaw/roll rotor 914 and a first tilt/yaw/roll rotor 917. A second controller board 943 is designed to controller a second yaw/roll rotor 924 and a second tilt/yaw/roll rotor 927. Referring back to FIG. 7, in various embodiments of the present invention, detector 903 is a multiplier to detect the phase difference between signals from first camera 318 and second camera 328. Please refer to Equations 1-3 above. Computer 1040 uses AI-based algorithms to intelligently assign tasks to first camera 318 and second camera 328 so as cameo gimbal 400 achieves optimal performance.

Referring back to FIG. 8, inertial Measurement Units (IMUs) 811,821, and 831 are small electronic devices consisting of some combination of gyroscopes, accelerometers and magnetometers. Once processed through a fusion algorithm, these IMU sensors 811,821, and 831 can accurately measure the orientation of a device such as cameo gimbal 400 in 3D space. In various embodiments of the present invention, IMU sensors 811, 821, and 831 are sensor fusion can broadly be categorized as software vs.

hardware fusion. In software fusion, the motion sensor data is fed to main controller board 931, first controller board 942, and second controller board 943 that then executes fusion algorithms, such as the Kalman, Madgwick or Mahony algorithms. Hardware fusion involves embedding a dedicated processor such as main controller board 931, first controller board 942, and second controller board 943 along with the motion sensors such that the fusion algorithms are executed on the embedded processor, the outputs of which are then provided to separate GPU/CPU 1041. Hardware fusion off-loads sophisticated filtering and auto-calibration onto an optimized processor resulting in better response and accuracy. IMUs 811, 821, and 831 with hardware fusion was selected to measure positional data. IMUs 811, 821, and 831 are as small and lightweight as possible. It also required some degree of accuracy and needed to be easy to use. In various embodiments of the present invention, the Ultimate Sensor Fusion Solution may be used as it met the above criteria and provided extensive support documentation. This sensor integrates the MPU9250 IMU (InvenSense, TDK Corp.), the M24512 12C EEPROM (STMicroelectronics N. V.), and the EM7180 sensor hub (EM Microelectronic-Marin SA). The MPU9250 IMU is a nine-axis microelectromechanic system (MEMS) motion sensor with embedded accelerometers, gyroscopes and magnetometers. The 64Kbyte M24512 I2C EEPROM stores the sensor configuration file and warm start parameters, which allows for faster initialization times by saving previous initialization and calibration parameters. The EM7180 is a sensor fusion hub (or motion sensor co-processor) takes sensor data from a slave accelerometer, gyroscope, and magnetometer and fuses them. This additional processor allows for better sensor data provided by the MPU9250, excellent dynamic calibration and filtering algorithms, and higher processing speeds.

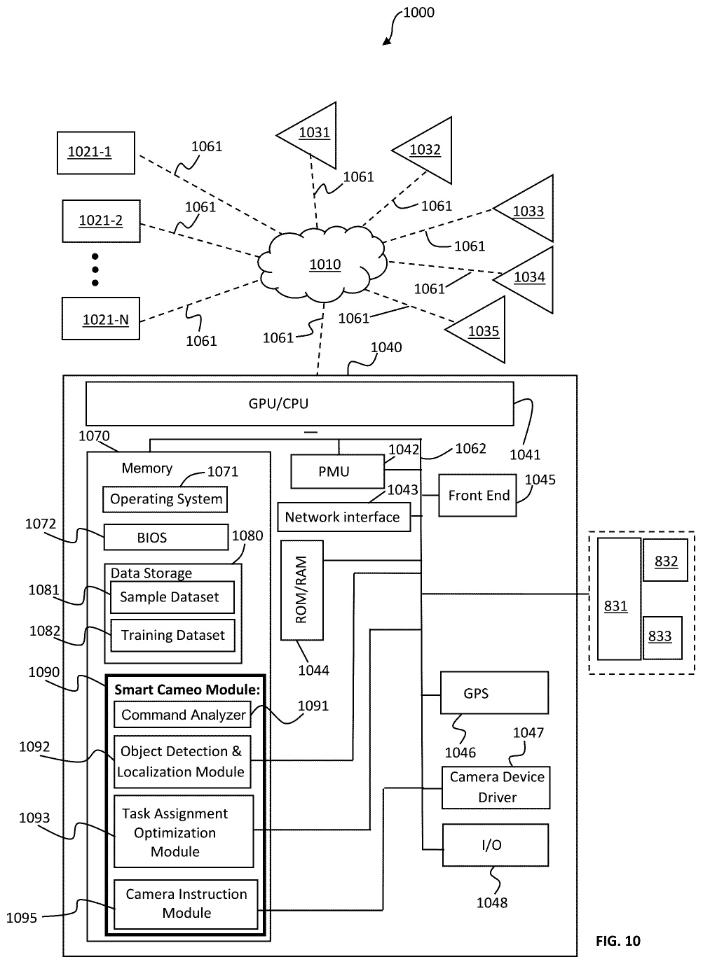

Continuing with FIG. 9, computer 1040 receives control signals from a remote control and command (C&C) center, a reference base station, or a soldier who sends wireless input signals to cameo gimbal system 400 or cameo gimbal system 600. These wireless input signals may include GPS locations of the targets and reference coordinates of the north east and down (NED) fixed reference coordinate system. Computer 1040 includes a receiver and a transmitter (please refer to FIG. 10). The receiver receives the wireless input signals from remote control. The local detector down converts the wireless input signals to baseband signals for further processing. A filter selects and cleans up the desired baseband signals. The transmitter sends various signals such as Euler angle information (Φ₁, θ₁, ψ₁), quaternion transformation signals, and GPS/INS signals. Main controller board 931, first controller board 942, and second controller board 943 may be a microprocessor that includes algorithms, a proportional, integral, and derivative (PID), a simultaneous localization and mapping (SLAM) unit, and Arithmetic Logic Unit (ALU) to calculate displacement error signals caused by the external forces. Then, computer 1040 outputs control currents therefrom. The proportional, integral, and derivative (PID) circuit inside is a servo control unit configured to control the speed and position of each IMU 811. 821, and 831 and the other operational aspects of cameo gimbal system 400. Each of main controller board 931, first controller board 942, and second controller board 943 receives a reference position together with the actual angular, linear speed velocities, and positions from cameo gimbal 400. Then, each of main controller board 931, first controller board 942, and second controller board 943 dynamically adjusts the velocities and positions so that the error signals are zero. A simultaneous localization and mapping (SLAM) unit uses the sensor data to estimate the current position of cameo gimbal 400. These signals are important to measure the error signals. A motor controller and hardware driver unit receive controlling signals derived from the error signals. The actuator system of cameo gimbal system 400 includes all rotors yaw rotor 902, roll rotor 904, first tilt rotor 911, first yaw/roll rotor 914, first tilt/yaw/roll rotor 917, second tilt rotor 921, second yaw/roll rotor 924, and second tilt/yaw/rotor 927 as described above and in FIG. 9. The IMUs return the output signals of all above-listed rotors to respective main controller board 931, first controller board 942, and second controller board 943. Next, the output signals cause cameo gimbal system 400 to operate accordingly.

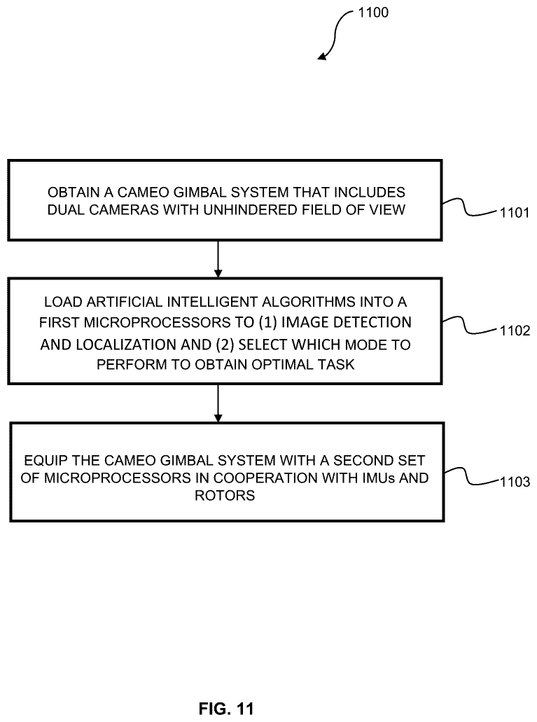

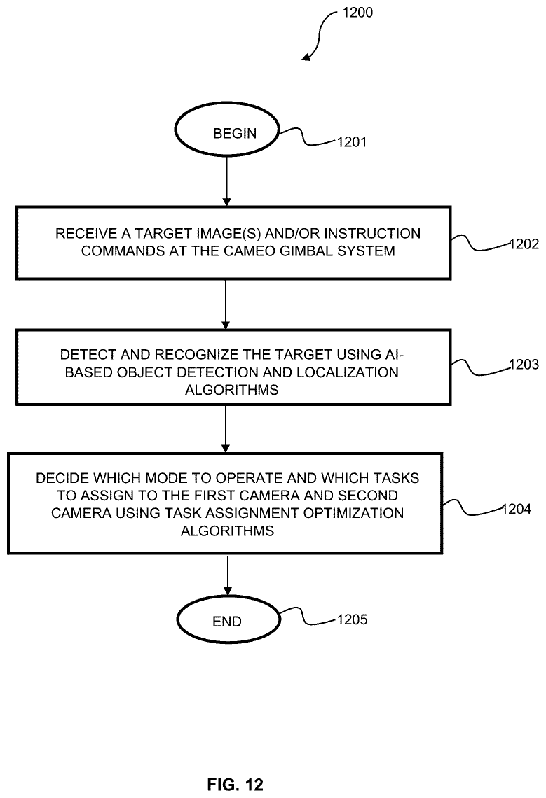

Next referring to FIG. 10, a schematic diagram of a cameo gimbal network 1000 (network 1000) designed to perform the network operations of the cameo gimbal system and auxiliary system in accordance with an embodiment of the present invention is illustrated. A smart cameo module (Artificial intelligence-based cameo ‘AI-based’) 1090 includes non-transitory computer executable instructions. These executable instructions, when executed by GPU/CPU 1041, perform all algorithms such as algorithms 1100 and 1200 of the present invention (please refer to FIG. 11 and FIG. 12). Onboard computer 1040 includes GPU/CPU 1041 in communication with a memory 1070 via a bus 1062. Onboard computer 1040 also includes a power management unit (PMU) 1042, a network interface 1043, a Read Only Memory (ROM), Random Access Memory (RAM) 1044, a front-end unit 1045, a GPS unit 1046, a drone device driver 1047, input/output interface 1048. PMU 1042 provides and manages power supplies to all components of onboard computer 1040. A memory 1070 stores Basic input/output system (BIOS) 1072 for controlling low-level operation of onboard computer 1040. Memory 1070 also stores an operating system (OS) 1071 for controlling the operation of onboard computer 1040. A data storage 1080 is dedicated to store a sample dataset 1081 and training dataset 1082. It will be appreciated that operating system (OS) and Basic input/output system (BIOS) 1072 may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components and/or operating system operations via Java application programs.

Continuing with FIG. 10, smart cameo module 1090 includes command analyzer module 1091, a object detection and localization module 1092, a task assignment optimization module 1093, and a camera instruction module 1094. In at least one of the various embodiments, while they may be illustrated here as separate modules, command analyzer module 1091, object detection and localization module 1092, task assignment optimization module 1093, and camera instruction module 1094 may be implemented as the same module and/or components of the same application. Further, in at least one of the various embodiments, command analyzer module 1091, object detection and localization module 1092, task assignment optimization module 1093, and camera instruction module 1094 may be implemented as operating system extensions, modules, plugins, applications, or the likes. In at least one of the various embodiments, command analyzer module 1091, object detection and localization module 1092, task assignment optimization module 1093, and camera instruction module 1094 may be implemented as hardware devices such as application specific integrated circuit (ASIC), combinatorial logic circuits, field programmable gate array (FPGA), software applications, and/or the combination thereof.

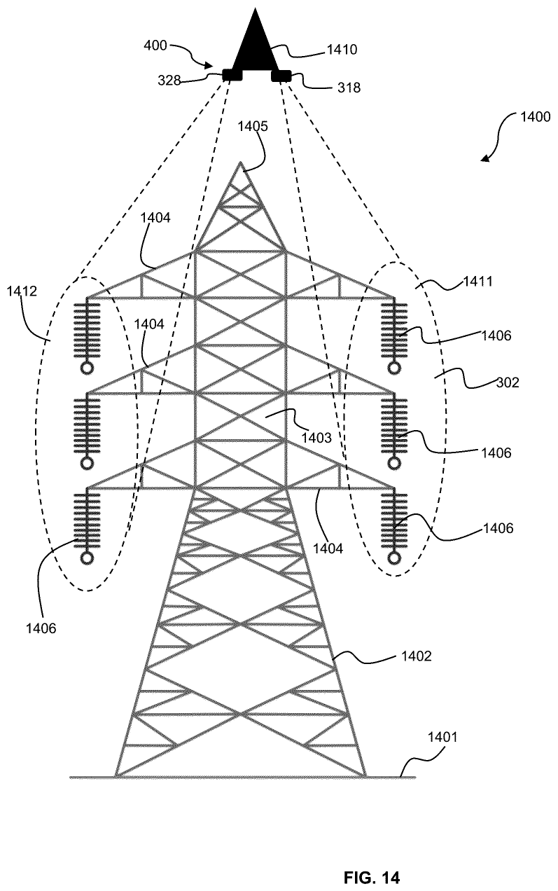

Referring again to FIG. 10, command analyzer module 1091 is configured to analyzer commands received from a group of remote computers 1021-1, 1021-2, . . . , 1021-N and/or at least one other drones or carriers 1031-1 to 1035. Group of remote computers 1021-1, 1021-2, . . . , 1021-N may be located at a remote command & control center (C³) in charge of sending tasks, controlling, and monitoring the operations of cameo gimbals. Alternatively, other drones or movable objects 1031-1 to 1035 can communicate with cameo gimbal 300 apropos of exchanging tasks and tactical information. Command analyzer module 1091 receives a command from group of remote computers 1021-1, 1021-2 . . . , 1021-N and/or at least one other drones or carriers 1031-1 to 1035. In various embodiments of the present invention, a command includes, inter alia, (1) a start section, (2) an 7-10 bit address frame, (3) a read and write (R/W) section, (4) an acknowledge and non-acknowledge (ACK/NACK) section, (5) a first data frame section, (6) a second acknowledge and non-acknowledge (ACK/NACK) section, (7) a second data frame section, (8) a third acknowledge and non-acknowledge (ACK/NACK) section, and (9) a stop section. First data frame section and second data frame section contain the image of the target and the assignments for first camera 318 and second camera 328. In the first data frame section, the assignment may be a surveillance of high-voltage transmission towers (please refer to FIG. 14). Thus, images of the high voltage transmission towers are included in second data frame section.

Continuing with FIG. 10, deep learning object detection module 1092 is configured to extract an image from either first or second data frame section. Then object detection module 1092 recognizes and zooms in and zoom out objects within the image. That is, deep learning object detection module 1092 does not only recognize but also zoom in and zoom out the objects of interest using bound boxes and feature extraction. In many embodiments of the present invention, object detection and localization module 1092 uses recurrent convolutional neural network (RCNN) to detect objects of interests. RCNN is a deep learning reinforced convolutional neural network (RCNN) that can recognize an object of interests and provide their location within bounding boxes without using a lot of training dataset. The RCNN used in the present invention is Faster RCNN from the TensorRT engine in the Open Neural Network Exchange (ONNX). The original RCNN model is a TensorFlow model having four layers and 100 regions of interests (ROI). The training and testing images are from COCO dataset with 80 classes. In the present invention, 6,000 images are used with 4,500 training images and 1,500 testing images. Each images has a size of 167×168 pixels. Once an image has been detected and localized, the zoom in and zoom out functions are assigned to the inherent functions of first camera 318 and second camera 328.

In some other embodiments, object detection and localization module 1092 uses computer graphics and linear classification algorithms such as vector support machines (SVM), kNN nearest neighbor, Euclidean distance, or linear regression models. Task assignment optimization module 1092 performs the following task assignment optimization algorithms to assign monocular mode/bipolar mode and assignments to which respective cameras to obtain optimal results. Continuing with FIG. 10, task assignment optimization module 1093 uses task assignment optimization algorithm as follows:

Continuing with FIG. 10, Let C₁(P₁ᵢ, a₁ᵢ, t₁ᵢ) be first camera 318 with a function of a position, assignment, and completion time, where P₁ᵢ is the position vector, a₁ᵢ is the assignment (or job), t₁ᵢ is the time to complete the assignment a₁ᵢ.

Let C₂(P₂ᵢ, a₂ᵢ, t₂ᵢ) be second camera 328 with a function of a position, assignment, and completion time, where P₂ᵢ is the position vector, a₂ᵢ is the assignment (or job), t₂ᵢ is time to complete the assignment a₂ᵢ.

Let T₁(P₁ₖ) be a first target with position vector P₁ₖ, and T₂(P₂ₖ) be a first target with position vector P₂ₖ.

T₁(P₁ₖ), T₂(P₂ₖ) where (their position vectors Pₗₘ is comprised of coordinate (x, y, z) in either Cartesian, cylindrical, or spherical coordinate 499).

Divide the space of cameo gimbal 400 and its carrier into a left space and a right space using imaginary frontal plane 491 and midsagittal plane 492. Frontal plane 491 and midsagittal plane 492 are going through the center gravity of the carrier (Hera drone) or cameo gimbal 400. Please refer back to FIG. 4.

If a₁ᵢ=a₂ᵢ, the assignments are jointly, then use binocular mode; else, if a₁ᵢ≠a₂ᵢ, the assignments are independent, then use monocular mode.

If a target lies on the same space with a camera, for example left half space 493 or right half space 494, then assign that target to that camera. For example, if the first target T₁(P₁ₖ) lies on the left half space 493 of midsagittal plane 492 with respect to first camera 318, then assign the first target T₁(P₁ₖ) to first camera 318 C₁(P₁ᵢ, a₁ᵢ, t₁ᵢ).

If P₁ᵢ, P₂ᵢ are the same (that is only one target); a₁ᵢ and a₂ᵢ are the same, then use assign a₁ᵢ and a₂ᵢ to either first camera 318 (C1) or second camera 328 (C₂).

If P₁ᵢ, P₂ᵢ are different (two different targets); a₁ᵢ and a₂ᵢ are independent, then use monocular mode. Assign the tasks to C₁ and C₂ based on:

$${min}_{ij} \{ {‖ {P}_{1 i} - {P}_{1 k} ‖}^{2} , {t}_{1 i} ; {‖ {P}_{2 i} - {P}_{2 k} ‖}^{2} , {t}_{2 i} \} = \{ \begin{matrix}true , & then {a}_{1 i} \to {C}_{1} and {a}_{2 i} \to {C}_{2} \\ false , & then {a}_{2 i} \to {C}_{1} and {a}_{1 i} \to {C}_{2}\end{matrix} ; where {‖ {P}_{1 i} - {P}_{1 k} ‖}^{2}$$

is the distances from either first camera 317 to target 611.

If P₁ᵢ, P₂ᵢ are undetermined, then move Hera drone to a position where P₁ᵢ, P₂ᵢ can be determined and repent the steps above.

Still continuing to FIG. 10, the carrier that bears cameo gimbal 400 may be remotely controlled by one of group of remote computers 1021-1 to 1021-N. Camera instruction module 1094 receives the command from command analyzer module 1091 to control first camera 318 and second camera 328 in either monocular mode or binocular mode and zooming in and zooming out instructions.

Still referring to FIG. 10, a front-end 1045 sends various signals such as Euler angle information (Φ₁, θ₁, ψ₁), quaternion transformation signals, and GPS/INS signals. Each of main controller board 941, first controller board 942, and second controller board 943 may be a microprocessor that includes algorithms, a proportional, integral, and derivative (PID), a simultaneous localization and mapping (SLAM) unit, and Arithmetic Logic Unit (ALU) to calculate displacement error signals caused by the external forces. Then, Each of main controller board 941, first controller board 942, and second controller board 943 outputs respective control currents therefrom. The proportional, integral, and derivative (PID) circuit inside main controller board 941, first controller board 942, and second controller board 943 is a servo control unit configured to control the speed and position of each IMU 811, 821, and 831 and the other operational aspects of cameo gimbal system 400. Each of main controller board 941, first controller board 942. and second controller board 943 receive a reference position together with the actual angular, linear speed velocities, and positions from cameo gimbal 400. Then, each of main controller board 941, first controller board 942, and second controller board 943 dynamically adjusts the velocities and positions so that the error signals are zero. A simultaneous localization and mapping (SLAM) unit uses the sensor data to estimate the current position of cameo gimbal 400. In an exemplary implementation of the present invention, power management unit (PMU) 1042, a network interface 1043, ROM/RAM 1044, front-end 1045, GPS unit 1046, drone device driver 1047, and input/output interface 1048 are well-known computer components in the arts and need not be described in details here. It is noted that, non-limiting examples of network 1010 include the internet, cloud computing, Software as a service (Saas), Platform as a service (PaaS), Infrastructure as a service (laaS), or permanent storage such as optical memory (CD, DVD, HD-DVD, Blue-Ray Discs), semiconductor memory (e.g., RAM, EPROM, EEPROM), and/or magnetic memory (hard-disk drive, floppy-disk drive, tape drive, MRAM) among others.

Continuing with FIG. 10, it will be appreciated that communication channel 1061 may include, but not limited to, short range wireless communication channels, mid-range wireless communication channels, and long range wireless communication channels. Long range wireless communication channels include UHF/VHF radio frequencies. It will be further appreciated that group of remote computers 1021-1, 1021-2, . . . , 1021-N, at least one client mobile devices 1031-1035 can be connected together in a master-slave configuration.

Referring now to FIG. 11, a method 1100 of obtaining a chameleon-eyes like gimbal system (cameo gimbal system) in accordance with an exemplary embodiment of the present invention is illustrated. Method 1100 is realized by cameo gimbal system 400 described in FIG. 3-FIG. 10 above. That is, after method 1100 is performed, cameo gimbal system 400 is obtained which includes the following characteristics:
(1) a gimbal system with unhindered field of views;
(2) each payload (i.e., first camera 318 and second camera 328) functions in either binocular mode or monocular mode like the eyes of a chameleon;
(3) a gimbal system that is smart and controlled by artificial intelligence based algorithms.

At step 1101, method 1100 begun by preparing all the components of cameo gimbal system. Step 1101 is realized by the components listed in FIG. 400. Step 1101 is also realized by cameo gimbal system 400 as described in FIG. 3 to FIG. 5 that operates as the chameleon eyes. Method 1100 begins by gathering all components of the spherical field of view (FOV) cameo gimbal system 400 of the present invention. The components of cameo gimbal system include mechanical components, software components, and electrical components. Mechanical components include curved suspension arm 301, main yaw rotor 302, first pot connector 303, main roll rotor 304, primary linking arm 306, second pot connector 307, third pot connector 308, first arcuate arm 310, first tilt rotor 311, first square L-shaped gimbal arm 312, fourth pot connector 313, first yaw/roll rotor 314, fifth pot connector 316, first tilt/yaw/roll rotor 317, and first camera 318. On the other side of curved suspension arm 301, second arcuate arm 320, second tilt rotor 321, second square L-shaped gimbal arm 322, sixth pot connector 323, second yaw/roll rotor 324, seventh pot connector 326, second tilt/yaw/roll rotor 327, and second camera 328. With this novel mechanical structure, step 1101 enables cameo gimbal system 400 unhindered spherical field of view that is not blocked by curved suspension arm 301. Other components of cameo gimbal system 400 includes electrical hardware and software. The software components includes non-transitory software components include any software programming language that can perform the feedback control operations described in FIG. 3 and FIG. 7 in the parent application entitled, “Spherical Field of View (FOV) Multiple Payloads Gimbal System and Method of Manufacturing the Same” filed on Dec. 4, 2022. The parent application is incorporated herewith in its entirety for references. In some aspects of the present invention, software components may include self-development kit (SDK) software, Pytorch, Keras, Caffee, Arduino, Mathlab, or C++. Electrical components include computer 1040, main controller board 941, first controller board 942, and second controller board 843. IMU includes IMUs 811, 821, and 831. Other electrical components are disclosed in FIG. 10. Please refer to Table 1 above for reference. In some embodiments of the present invention, hardware components may be made of microelectromechanical system (MEMS).

Next, at step 1102, artificial intelligence based algorithms are loaded into a first central processing unit (CPU)/graphic central unit (GPU). Step 1102 is realized by onboard computer 1040 described above, especially GPU/CPU 1041 and smart Cameo module 1090 that includes command analyzer module 1091, object detection and localization module 1092, task assignment optimization module 1093, and camera instruction module 1094. When cameo gimbal system 400 receives assignments and images of the targets of interests, command analyzer module 1091 understands the assignments (i.e., aerial photogrammetry). Object detection and localization module 1092 stores these images into data storage 1080. Task assignment optimization module 1093 uses task assignment optimization algorithms described above in FIG. 10 to assign which tasks to which cameras and what mode to use in order to optimally complete the given assignments. Within the scope of the present invention, optimization comprises selecting which mode (binocular or monocular) to use and which assignment to assign to which camera (first camera 318 or second camera 328) in order to complete the assignment (a₁ᵢ and a₂ᵢ) in the shortest time (tᵢ₁ and tᵢ₂), most efficient, and accurate results.

Next at step 1103, load the cameo gimbal system with a second set of microprocessors, IMUs, and rotors; the second set of microprocessors control IMUs and rotors. Step 1003 is realized by microprocessors 881-883, IMUs 811, 821, and 831, and rotors 902, 904, 911, 914, 917, 921, 924, and 927. Please refer to FIG. 3, FIG.5, and FIG. 8-FIG. 10 for more details.

After method 1100 is realized, cameo gimbal 400 as described above is ready to use.

Next referring to FIG. 12, a flow chart of a method 1200 of operating a smart (AI-based) cameo gimbal in accordance with an aspect of the present invention is illustrated. Method 1200 is realized by non-transitory Java or Python computer language when executed by GPU/CPU 1041 it performs the following steps:

At step 1201, the operation of the cameo gimbal begins. During step 1201, first camera 318 and second camera 328 are returned to the initial position as shown in

FIG. 4. Sample dataset 1081 and training dataset 1082 are loaded with images of possible targets of interests. In the present invention, the dataset is a CoCo dataset which includes 4,500 training images and 1,500 test images. In addition, electrical system layout as described in FIG. 9 and FIG. 10 are initialized and tested to ensure network 1000 is working properly. In preferred embodiments of the present invention, cameo gimbal system 400 is carried by a carrier such as Hera drone. Hera® drone described in detailed in a patent application entitled, “Method for Destroying the Enemy's Targets Using Missiles Launched from Drones Carried Inside Soldiers' Backpacks”, filed on Jul. 17, 2022, application Ser. No. 17/813,042, by the same inventor (Quoc Viet Luong).

At step 1202, a command is received that includes images of interests and instructions (or assignments). Step 1202 is realized by front-end 1045 that includes receiver, detector, filter, and transmitter. As alluded above a command includes, inter alia, (1) a start section, (2) an 7-10 bit address frame, (3) a read and write (R/W) section, (4) an acknowledge and non-acknowledge (ACK/NACK) section, (5) a first data frame section, (6) a second acknowledge and non-acknowledge (ACK/NACK) section, (7) a second data frame section, (8) a third acknowledge and non-acknowledge (ACK/NACK) section, and (9) a stop section. First data frame section and second data frame section contain the image of the target and the assignments for first camera 318 and second camera 328. In addition, during operation, step 1202 is realized by electrical system 900 in 900 within network 1000 to ensure that cameo gimbal system 400 is working properly. More specifically, first microprocessor 831, second microprocessor 832, and third microprocessor 833 control the respective operations of IMUs 811, 821, and 831 in connections with rotors 902, 904, 911, 914, 917, 921, 924, and 927 respectively.

Next at step 1203, the target is detected and localized using AI-based algorithms. Step 1203 is realized by object detection and localization module 1092 that uses recurrent convolutional neural network (RCNN) algorithms to provide bounding boxes and their coordinates of each targets. The RCNN model is constructed from ONNX open source framework.

Finally, at step 1204, monocular or binocular operation mode and optimization procedures are performed to achieve optimal results. Step 1204 is realized by smart cameo module 1090 in onboard computer 1040. More particularly, command analyzer module 1081 understands the assignment (a₁ᵢ and a₂ᵢ). As targets of interests are detected and localized by object detection and localization module 1092, the positions (P₁ₖ and P₂ₖ) are known. Based on that, task assignment optimization module 1093 uses task assignment optimization algorithms described in FIG. 10 above to determine which task to assign to which camera (first camera 318, second camera 328), which mode to use (binocular mode or monocular mode), and what drone's position to take in order to optimize the results. Please refer the description of the task assignment optimization algorithms above for more details.

Finally, at step 1205, the operation of cameo gimbal system ends. As each assignment (a₁ᵢ and a₂ᵢ) completed and Hera drone returns to base. The operations of cameo gimbal system 400 ends.

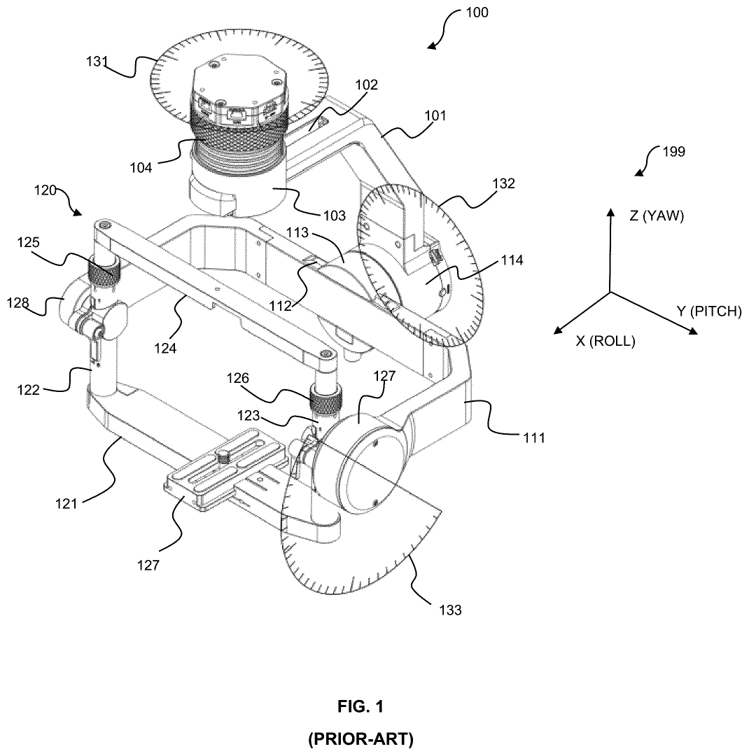

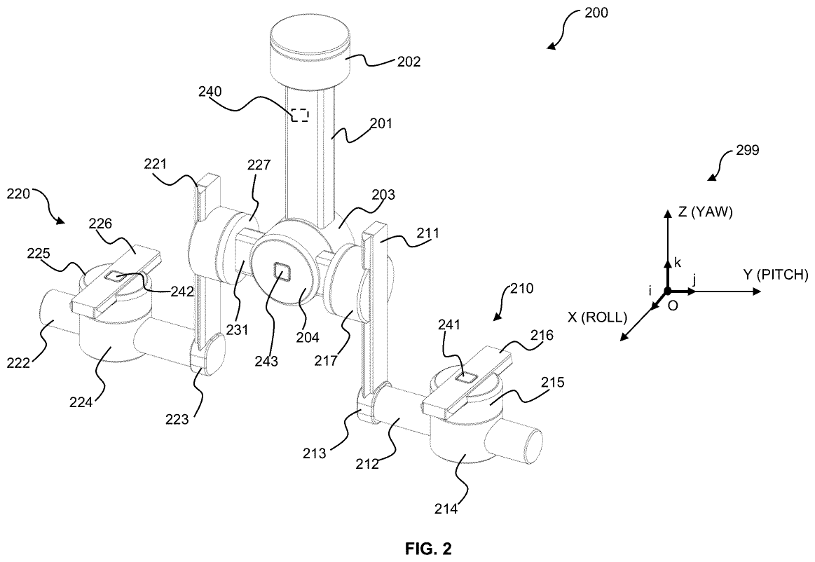

From the disclosure of FIG. 1 to FIG. 12 above, the following targets of the present invention are achieved:
(a) simple mechanical structure of a cameo gimbal system that can achieve 360° spherical field of view (FOV) without visual restrictions.
(b) an AI-based cameo gimbal system that can optimize the performance of the cameo gimbal system.
(c) a method for obtaining chameleon eyes like gimbal without any visual restrictions.
(d) a method for operating such AI-based cameo system to obtain optimal results.

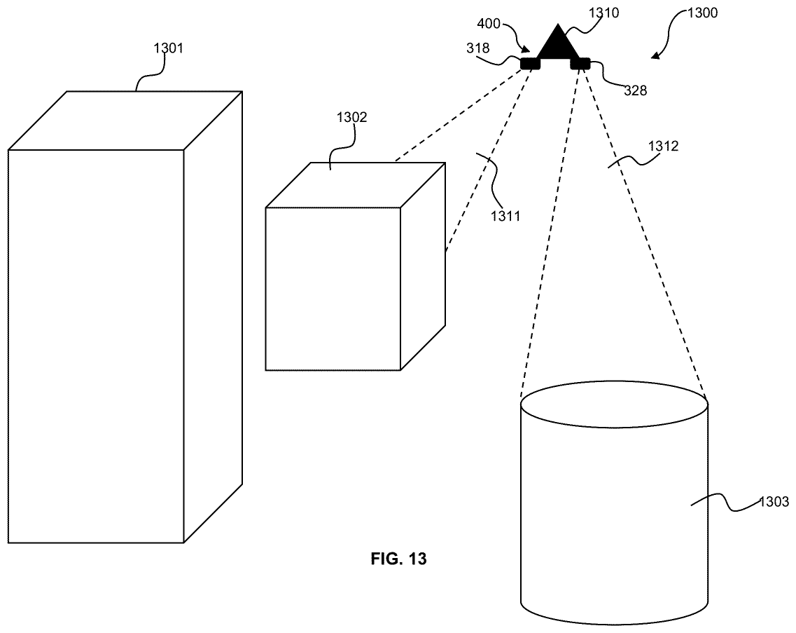

Next, FIG. 13 and FIG. 14 illustrate the applications and operations of the cameo gimbal of the present invention.

In FIG. 13, an application of cameo gimbal 300 in telegraphic mapping and land surveying is illustrated. In one exemplary illustration, a first building 1301 and a second building 1302 on the left hand side and a third building 1303 is on the right hand side. A carrier 1310 carries cameo gimbal 300 with first camera 318 and second camera 328 is flying from outside to inside of FIG. 13. In such assignment (a₁ᵢ and a₂ᵢ), task assignment optimization module 1093 uses the task assignment optimization algorithms described above in FIG. 10 to select operation mode and camera assignment. In the present application, the monocular mode is selected since ati disjoint and independent from a₂ᵢ. Left hand side area is assigned to fist camera 318 because the distances from targets on the left hand side are closer to first camera 318 than those of second camera 328. As a result, first camera 318 is scanning and surveying first building 1301 and second building 1302 with a first field of view (FOV) 1311. By the same reasons, because the distances between third building 1303 is closer to second camera 328 than those of first camera 318, second camera 328 is scanning and surveying third building 1303 with a second FOV 1312. Carrier 1310 such as, but not limited to, a drone receives instructions to survey the construction site 1300 in monocular mode. In the monocular mode, cameo gimbal 400 is independently transmitting independent images (from first building 1301, second building 1302, and third building 1303) back to command center 901. The images of first building 1301 and second building 1302 are sent from first camera 318. Third building 1303 is independently transmitted via second camera 328.

Continuing with FIG. 13, more specifically, the drone that carriers cameo gimbal 400 which is equipped with onboard computer 1040, first camera 318 and second camera 328 receives a command at onboard computer 1040. Onboard computer 1041 contains receiver 902 including detector 903. The command contains an instruction to monitor the construction site 1300 independently. Command analyzer 1091 receives the instruction and assigns this task to both first camera 318 and second camera 328 according to task assignment optimization algorithm described above. In the meantime, the images of construction site 1300 are also received. Object detection and localization module 1092 recognize these input images using either linear classification models or RCNN algorithms with zooming in and zooming out capabilities. Task assignment optimization module 1093 determines which assignment is assigned to which camera. Once the assignments have been determined, camera device driver 1047 issues commands to control first camera 318 and second camera 328. More particularly, camera instruction module 1094 issues commands to main controller board 941, first controller board 842, and second controller board 843. As first camera 318 is scanning surveying first building 1301 and second building 1302, second camera 328 independently scans surveying third building 1303. First camera 318 and second camera 328 transmit back the images to command centers 1021-1, 1021-2, . . . 1021-N. via network 1010 and communication links 1061. Alternatively, the images are sent to other carriers 1031-1035 for strategic coordination such as exchanging photogrammetric images.

Continuing with FIG. 13, in the same scenario, drone 1310 and cameo gimbal 400 can be used to perform remote monitoring and progress reports as well as equipment tracking. Each of first camera 318 and second camera 328 keeps track of each equipment location on construction site 1300. With cameo gimbal system 400 and onboard computer 1040, drone 1310 can guide construction vehicles to avoid overstepping, extraneous resources, thus improving efficiency. Yet in the same scenario, drone 1310 can perform security surveillance of construction site 1300. Any unauthorized personnel or vehicles can be detected by drone 1310. As the unauthorized are detected, cameo gimbal 400 may switch from monocular mode to binocular mode as described in FIG. 6 with zooming in and zooming out capabilities. Clear and zoomed in pictures of the unauthorized are transmitted back to command center 1021-1 to 1021-N. Yet in the same scenario, personal safety commands can be carried out to safeguard human lives of workers using carrier 1030 and cameo gimbal 400. In another scenario, carrier 1030 equipped with first camera 318 and second camera 328 can fly up to measure the height of first building 1301 without having the workers to climb up and down first building 1301.

Next referring to FIG. 14, another application of cameo gimbal 400 and on-board computer 1040 is illustrated. High-voltage transmission towers are usually placed in far-away areas away from the cities and densely populated areas because of the dangers caused by the high voltages. In addition, due to the high voltage and exposition to the elements, high-voltage transmission towers need regular check-ups to avoid malfunctions that cause black-outs and forest fires. A typical high-voltage transmission tower 1400 includes a tower body 1402, a cage 1403, cross arms 1404, and a peak 1405. Tower body 1402 is the main part of transmission tower 1400 which connects the boom and cage to a tower foundation 1401 on body extension or the leg extension. Tower foundation 1401 may be established over water, land, or dense forests. Cage 1403 is the area between tower body 1402 and peak 1405. Peak 1405 is mainly used for lay ground wire in suspension clamp and tension clamp in suspension and angle tower location. At the extreme ends of cross arms 1404 there are porcelain strain insulators 1406 designed to convert high AC voltages to DC voltages to reduce line losses.

Continuing with FIG. 14, a drone 1410 carrying cameo gimbal 400 equipped with first camera 318 and second camera 328 is assigned to perform structure inspection and aerial photography of high-voltage transmission tower 1400. More specifically, drone 1410 that carriers cameo gimbal 400 is equipped with onboard computer 1040, first camera 318 and second camera 328 receives a command at front end 1045. Front-end 1045 contains receiver including a downconverter. The command contains an instruction to inspect and photograph high-voltage transmission tower 1400 using either monocular mode or binocular mode. Command analyzer 1091 receives the instruction and assigns this task to both first camera 318 and second camera 328. In the meantime, the images of high-voltage transmission tower 1400 and porcelain insulators 1406 are also received. Object detection and localization module 1092 recognizes these images of porcelain insulators 1406 using RCNN algorithms with zooming in and zooming out capabilities. Task assignment optimization module 1093 with the aids of GPS unit 1046 determines the best course to fly the drone 1410 based on the task assignment optimization algorithms described above in FIG. 10. Camera device driver 1047 is a firmware that drives rotors 302, 304, 311, 314, 317, 321, 324, and 327. Camera instruction module 1094 issues commands to GPU/CPU 1041 executes the instructions from the task assignment optimization algorithms. Then GPU/CPU 1041 issues commands to main controller board 941, first controller board 942, and second controller board 843. As first camera 318 scanning surveying high-voltage transmission tower 1401 and porcelain insulators 1406, second camera 328 is independently scans surveying porcelain insulators 1406. First camera 318 and second camera 328 independently transmit back the images to command centers 1021-1, 1021-2, ... 1021-N. via network 1010 and communication links 1061. Please refer to FIG. 10 for more descriptions.

Thus from examples in FIG. 13 and FIG. 14, cameo gimbal system 400

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

Within the scope of the present description, the reference to “an embodiment” or “the embodiment” or “some embodiments” means that a particular feature, structure or element described with reference to an embodiment is comprised in at least one embodiment of the described object. The sentences “in an embodiment” or “in the embodiment” or “in some embodiments” in the description do not therefore necessarily refer to the same embodiment or embodiments. The particular feature, structures or elements can be furthermore combined in any adequate way in one or more embodiments.

Within the scope of the present description, the words “connected” “connecting”, “coupled”, “coupling”, “connections”, “bolted”, “laid”, “positioned”, “attached”, “attaching”, “affixed”, “affixing” are used to mean attaching between two described members using screws, nails, tongs, prongs, clips, spikes, staples, pins, male and female nuts, buttons, sleeves, lugs, cams, handles, bars, fasteners, connectors, or the likes.

Within the scope of the present description, the words “connected”, “connecting”, “coupled”, “coupling”, “connections”, are used to mean wired and/or wireless connections. Wired connections include electrically conducting wires, cables, lines, coaxial cables, strips, or the likes. Conducting wires are made of conductors such as coppers, aluminum, gold, or the likes. Wireless connections include electromagnetic waves, short range communication channels include ZigBee™/IEEE 802.15.4, Bluetooth™, Z-wave, NFC, Wi-fi/802.11, cellular (e.g., GSM, GPRS, WCDMA, HSPA, and LTE, 5G, etc.), IEEE 802.15.4, IEEE 802.22, ISA100a, wireless USB, and Infrared (IR), LoRa devices, etc. Medium range wireless communication channels in this embodiment of communication link 161 include Wi-fi and Hotspot. Long range wireless communication channels include UHF/VHF radio frequencies.

Within the scope of the present description, the word “network” includes data center, cloud network , or network such as nano network, body area network (BAN), personal area network (PAN), local area network (LAN), campus/corporate area network (CAN), metropolitan area network (MAN), wide area network (WAN), and mesh area networks, or any combinations thereof.

Within the scope of the present description, the word “rotation”, “rotating”, “rotate” includes clockwise and/or counterclockwise direction.

Within the scope of the present invention, the Cartesian XYZ coordinate (x,y,z) also includes equivalent spherical coordinate (r, θ, Φ), and/or cylindrical coordinate (r, θ, z) that can determine the Euler angle of arbitrary rotations in 3D space.

### DESCRIPTION OF NUMERALS

100 prior-art 3-axis gimbal
101 first gimbal frame
102 first position adjustment slot
103 yaw motor (or rotor)
104 first rotating ball nut
111 second gimbal frame
112 second position adjustment slot
113 roll motor
114 second rotating ball nut
120 third gimbal frame
121 bottom horizontal bar
122 vertical support
123 vertical support
124 top horizontal bar
125 height adjusting screw
126 height adjusting screw
127 pitch motor
128 pitch motor
131 yaw plane
132 roll plane
133 pitch plane
199 Cartesian Coordinate system
200 Duo payload spherical field of view gimbal
201 suspension arm
202 first connector
203 first position adjustment pot connector
204 first roll rotor
210 second L-shaped gimbal arm
211 first section
212 second section
213 first L-shape gimbal arm joint
214 second position adjustment pot connector
215 first yaw rotor
216 first payload support
217 third position adjustment pot connector
218 first pitch rotor
220 second L-shaped gimbal arm
221 third section
222 fourth section
223 second joint
224 third position adjustment pot connector
225 second yaw rotor
226 second payload support
227 fourth position adjustment pot connector
228 second pitch rotor
231 first gimbal arm
240 controller circuit board
241 first IMU
242 second IMU
243 third IMU
300 cameo gimbal system
301 curved suspension arm
302 main yaw rotor
303 first pot connector
304 main roll rotor
305 gimbal arm supporting plate
306 primary linking arm
307 second pot connector
308 third pot connector
310 first curved L-shaped gimbal arm
311 first tilt rotor
312 firs square L-shaped gimbal arm
312a first section
312b base section
313 fourth pot connector
314 first yaw/roll rotor
315a top section
315b base section
316 fifth pot connector
317 tilt/yaw/roll rotor
318 first camera (payload)
320 second curved L-shaped gimbal arm
321 second tilt rotor
322 second square L-shaped gimbal arm
322a top section
322b base section
323 sixth pot connector
324 second yaw/roll rotor
325a top section
325b base section
326 seventh pot connector
327 second tilt/yaw/roll rotor
328 second camera
399 earth bound Cartesian coordinate system
411 first IMU
421 second IMU
431 third IMU
491 frontal plane (XY plane)
492 midsagittal plane (ZZ plane)
493 left side space
494 right side space
499 earth bound Cartesian coordinate system
599 earth bound Cartesian coordinate system
600 cameo gimbal system in opposite field of view
601 field of view of first camera
602 field of view of second camera
611 first target of interest
612 second target of interest
700 cameo gimbal system in binocular mode
701 field of view of first camera
702 field of view of second camera
711 target
721 distance B between two cameras
722 distance between target and first camera
723 distance between target and second camera
799 earth bound Cartesian coordinate system
800 electrical
811 first IMU
821 second IMU
831 third IMU
841 main controller board
842 first controller board
843 second controller board
851 electrical communication bus
861 non-volatile memory
862 random access memory (RAM)
900 cameo gimbal system layout
902 main yaw rotor
904 main roll rotor
911 first tilt rotor
914 first yaw/roll rotor
917 first tilt/yaw/roll rotor
918 first camera
921 second tilt rotor
924 second yaw/roll rotor
927 second tilt/yaw/roll rotor
928 second camera
941 main controller board
942 first controller board
943 second controller board
1000 cameo gimbal system
1010 cloud network
1021-1 first base station or command station
1021-2 second base station or command station
1021-N Nth base station or command station
1031 first carrier (drone)
1032 second carrier
1033 third carrier
1034 fourth carrier
1035 fifth carrier
1040 cameo onboard computer
1041 GPU/CPU
1042 power supply
1043 network interface
1044 ROM/RAM
1045 front-end
1046 GPS unit
1047 drone device driver
1048 input/output (I/O) unit
1070 memory
1071 Operating system
1072 BIOS
1080 Non-transitory data storage
1081 sample dataset
1082 training dataset
1090 Smart cameo module (AI-based)
1091 command analyzer module
1092 object detection and localization module
1093 task assignment and optimization module
1094 camera instruction module (chameleon eyes module)
1300 construction site
1301 first building
1302 second building
1303 third building
1310 drone
1311 first FOV in monocular mode
1312 second FOV in monocular mode
1400 high voltage transmission tower
1401 tower foundation
1402 tower body
1403 cage
1404 cross arms
1405 peak
1406 porcelain insulators
1411 first FOV
1412 second FOV

1. A chameleon-eyes like gimbal system (“cameo gimbal system”), comprising:
(a) a curved suspension arm having a first terminal and a second terminal, wherein said first terminal is connected to a movable object that transports said cameo gimbal system;
(b) a main linking arm connected to said second terminal at a right angle via a first pot connector and a main roll rotor;
(c) a first square L-shaped gimbal arm connected to said main linking arm by a second pot connector and a first tilt rotor;
(d) a first curved L-shaped arm connected underneath said first square L-shaped gimbal arm by a third pot connector and a first yaw/roll rotor;
(e) a second square L-shaped gimbal arm connected to said main linking arm by a fourth pot connector and a second tilt rotor;
(f) a second curved L-shaped arm connected underneath said second square L-shaped gimbal arm by a fifth pot connector and a second yaw/roll rotor;
(g) a first payload device connected to said first curved L-shaped gimbal arm by a sixth pot connector and a first tilt/roll/yaw rotor; and
(h) a second payload device connected to said second curved L-shaped gimbal arm by a seventh pot connector and a second tilt/roll/yaw rotor.

2. The cameo gimbal system of claim 1 wherein said first square L-shaped gimbal arm further comprises:
a top straight section connected to said second pot connector and said first tilt rotor; and
a base straight section connected to said top straight section at a right angle; and
wherein said top section is coupled to said first arcuate gimbal arm by said third pot connector and said first yaw/roll rotor.

3. The cameo gimbal system of claim 1 wherein said second square L-shaped gimbal arm further comprises:
a top straight section; and
a base straight section connected to said top straight section at a right angle; and
wherein said top section is coupled to said second arcuate gimbal arm by said sixth pot connector and said second yaw/roll rotor.

4. The cameo gimbal system of claim 1 wherein said first arcuate gimbal arm further comprises:
a top straight section; and
a curved base section connected to said stop straight section; wherein said top straight section is connected to said first square L-shaped gimbal arm by said third pot connector and said first yaw/roll rotor and said curved base section is connected to said fourth pot connector and said first tilt/yaw/roll rotor.

5. The cameo gimbal system of claim 1 wherein said second arcuate gimbal arm further comprises:
a top straight section; and
a curved base section connected to said stop straight section; wherein said top straight section is connected to said second square L-shaped gimbal arm by said sixth pot connector and said second yaw/roll rotor and said curved base section is connected to said seventh pot connector and said second tilt/yaw/roll rotor.

6. The cameo gimbal system of claim 5 further comprises a main inertia measurement unit (IMU) configured to sense angular velocities, directions, and linear accelerations of said main roll rotor and said main yaw rotor.

7. The cameo gimbal system of claim 6 further comprises a first measurement unit (IMU) configured to sense angular velocities, directions, and linear accelerations of said first tilt rotor, said first yaw/roll rotor, and said first tilt/yaw/roll rotor.

8. The cameo gimbal system of claim 6 further comprising a second measurement unit (IMU) configured to sense said angular velocities, directions, and linear accelerations of second tilt rotor, said second yaw/roll rotor, and said second tilt/yaw/roll rotor.

9. The cameo gimbal system of claim 8 further comprising a main controller board configured to operate said main IMU, said main yaw rotor, and said main roll motor.

10. The cameo gimbal system of claim 9 further comprising a first controller board configured to operate said first IMU, said first tilt rotor, said first yaw/roll rotor, and said tilt/yaw/roll rotor.

11. The cameo gimbal system of claim 10 further comprising a second controller board configured to operate said second IMU, said second tilt rotor, said second yaw/roll rotor, and said tilt/yaw/roll rotor.

12. The cameo gimbal system of claim 10 further comprising a computer, located on said suspension arm, operable to control operations and assignments of said main controller board, said first controller board, and said second controller board using an artificial intelligence based module.

13. The cameo gimbal system of claim 12 wherein said artificial intelligence based module further comprises:
a task assignment optimization module operable to select which assignments to assign to either said first camera or said second camera and which operation mode is used; and
an object recognition and localization module operable to recognize and determine coordinates of an target using a deep learning algorithm.

14. The cameo gimbal system of claim 13 wherein said operation mode further comprises a binocular mode and a monocular mode; wherein in said binocular mode said first camera and said second camera operate jointly to achieve a common objective, and wherein in said monocular mode said first camera and said second camera operate independently to one another to achieve different objectives.

15. The cameo gimbal system of claim 14 further comprises a front-end unit which further comprises:
a receiver for receiving commands from a remote center;
a detector operable to detect said commands; and
a transmitter for transmitting information from said first camera and said second camera.

16. A method of searching and detecting a target using said chameleon eyes like gimbal system (“a cameo gimbal system”) of claim 1, comprising:
(a) providing said cameo gimbal frame a plurality of controller boards, a plurality of inertia measurement units (IMUs), and a plurality of rotors so that said cameo gimbal frame operate said first payload comprising a first camera and said second payload comprising a second camera independently like chameleon's eyes characterized by each camera having unhindered field of views and ability to operate in a monocular or binocular mode; and
(b) operating said first camera and said second camera in either said monocular mode or said binocular mode to search and detect said target; and
(c) deciding which assignments to assign to either said first camera or said second camera.

17. The method of claim 16 wherein said assignments comprise recognizing and determining locations of different targets.

18. The method of claim 16 wherein said step (b) of operating said first camera and said second camera in either a monocular mode or a binocular mode further comprises:
(i) detecting whether said first camera and said second camera are operating jointly or independently and
(j) if said first camera and said second camera operate independently to one another to obtain different objectives, then use said monocular mode; else, use said binocular mode.

19. The method of claim 18 wherein said step (c) of deciding which assignments to assign to either said first camera or said second camera further comprises
(i) determining coordinates of said targets;
(j) determining distances between said targets and said first camera and said second camera using said coordinates of said targets; and
(k) comparing said distances between said targets and said first camera and said second camera; and
(k) if said distances between said first camera and said targets are less than said distances between said second camera and said targets, then assigning said assignments to said first camera; else, assigning said assignment to said second camera.

20. The method of claim 19 wherein said step (c) of deciding which assignments to assign to either said first camera or said second camera further comprises:
(l) calculating a first time to complete said assignments for said first camera; and
(m) calculating a second time to complete said assignments for said second camera; and
(n) if said first time is less than said second time then assign said assignment to said first camera; else, assigning said assignment to said second camera.
